(19) United States
(12) Patent Application Publication
(10) Pub. No.: US 2026/0224441 A1
(43) Pub. Date: Aug. 6, 2026

(54) CRYOSTORAGE DEVICES AND METHODS

(71) Applicant: ABT HOLDING COMPANY, Cleveland, OH (US)

(72) Inventors: Bradley Barber, Dodge Center, MN (US); Jeffrey Brown, Rochester, MN (US); John A. Corey, Melrose, NY (US); Matthew John Foust, Fountain City, WI (US); Erik Victor Morness, Saint Paul, MN (US); Benjamin Charles Williams, Rochester, MN (US); Daniel Ashley Wright, Rochester, MN (US); Junjie Zhu, Arden Hills, OH (US)

(21) Appl. No.: 19/148,540

(22) PCT Filed: Jan. 11, 2024
(86) PCT No.: PCT/US2024/011158

§ 371 Date: Jul. 16, 2025

Related U.S. Application Data
(60) Provisional application No. 63/439,250, filed on Jan. 16, 2023.

(51) Int. Cl. A61J 1/16; F25B 19/00

(52) U.S. Cl. CPC A61J 1/165; F25B 19/005

(57) ABSTRACT

A cryostorage unit includes a cryochamber having a cryo-access port at an upper portion of the cryochamber. The cryochamber defines an internal volume substantially surrounding at least one rack. The cryo-access port is configured to selectively place the internal volume in fluid communication with an ambient space. A cooling agent induces cryogenic temperatures within a first temperature range to the interior volume. A carousel deck is located within the internal volume adjacent the cryo-access port. The carousel deck is located substantially above the at least one rack and suspends the at least one rack downward therefrom into the internal volume. At least one carousel bearing is located in the internal volume and engages with the carousel deck rotational motion of the carousel deck relative to the cryochamber. The carousel deck rotates substantially horizontally.

### RELATED APPLICATIONS

This application claims priority from U.S. Provisional Application No. 63/439,250, filed 16 Jan. 2023, the subject matter of which is incorporated herein by reference in its entirety.

### TECHNICAL FIELD

This disclosure relates to an apparatus and method for cryostorage and, more particularly, to methods and apparatuses for facilitating cryostorage and manipulation of a plurality of container units.

### BACKGROUND

In a medical setting, it is sometimes desirable to securely and cryogenically store substances (e.g., medications or other therapeutics) at extremely low temperatures. Individual containers of the substance may be provided for single-use dispensing from a cryostorage apparatus, but access to one container should avoid undesirably warming other stored containers which are not intended for immediate use.

Additionally, providing a user with periodic access to the cryostorage apparatus may result in admission of relatively moist air to an interior volume, which could cause undesirable ice buildup.

Finally, it may be desirable, in some use environments, for the substance to be warmed from the cryogenic temperatures in a controlled manner before being provided to a user. For example, for some stored substances, facilitating the transition from frozen to liquid form may be important in maintaining useful value of the substance, which may be rare, fragile, and/or expensive to replace if damaged during thawing.

Cryostorage apparatuses and methods are disclosed in U.S. Pat. No. 11,566,834, issued 31 Jan. 2023 and titled “Apparatus and Method for Cryostorage and Manipulation of a Plurality of Container Units” (hereafter, “the '834 patent”), which is incorporated by reference herein in its entirety for all purposes.

### SUMMARY

In an aspect, alone or in combination with any other aspect, a cryostorage unit is described. A cryochamber includes a cryo-access port at an upper portion of the cryochamber. The cryochamber defines an internal volume substantially surrounding at least one rack. The cryo-access port is configured to selectively place the internal volume in fluid communication with an ambient space. A cooling agent induces cryogenic temperatures within a first temperature range to the interior volume. A carousel deck is located within the internal volume adjacent the cryo-access port. The carousel deck is located substantially above the at least one rack and suspends the at least one rack downward therefrom into the internal volume. At least one carousel bearing is located in the internal volume and engages with the carousel deck for rotational motion of the carousel deck relative to the cryochamber. The carousel deck rotates substantially horizontally.

In an aspect, alone or in combination with any other aspect, a cryostorage unit is described. A cryochamber is configured to store at least one rack in a cryogenic internal volume defined by the cryochamber. The cryochamber includes a cryo-access port at an upper portion of the cryochamber. The cryo-access port is configured to place the internal volume in fluid communication with an ambient space via a port aperture extending through a top cryochamber surface. The cryo-access port is at least partially defined by a port collar in fluid communication with the port aperture and extending longitudinally upward beyond the upper portion of the cryochamber. A cork selectively occludes the cryo-access port for resisting ingress of ambient air to the cryochamber. The cork includes a lower cork body having a first cross-sectional footprint and configured for selective nesting engagement within the port collar. The cork includes an upper lid feature having a second cross-sectional footprint, larger in at least one dimension than the first cross-sectional footprint. At least a portion of the port collar includes a cork seat feature configured for selective engagement with at least a portion of the upper lid feature to resist travel of fluid along a longitudinal fluid path between the cork and the port collar.

In an aspect, alone or in combination with any other aspect, a cryostorage unit is described. A cryochamber is configured to store at least one rack in a cryogenic internal volume defined by the cryochamber. The cryochamber includes a cryo-access port at an upper portion of the cryochamber. The cryo-access port is configured to place the internal volume in fluid communication with an ambient space via a port aperture extending through a top cryochamber surface. A cork selectively occludes the cryo-access port for resisting ingress of ambient air to the cryochamber. A dry air supply device is at least partially external to the cryogenic internal volume. The dry air supply device includes a dry air supply line in fluid communication with at least a chosen one of the cryogenic internal volume and the cryo-access port. The dry air supply device selectively provides dry air to volumetrically prevent intrusion of non-dry air within the chosen one of the cryogenic internal volume and the cryo-access port.

In an aspect, alone or in combination with any other aspect, a material thawing device is described. The material thawing device includes a stepper motor and an eccentric cam operatively coupled to the stepper motor and receiving orbital motion therefrom. A mobile platform is selectively driven by the eccentric cam into orbital motion within a motion plane with respect to the stepper motor. The motion plane is substantially parallel to the mobile platform. At least one container station is supported by the mobile platform for orbital motion parallel to the motion plane. The at least one container station includes a heating element for selectively heating a container associated with the container station.

### BRIEF DESCRIPTION OF THE DRAWINGS

For a better understanding, reference may be made to the accompanying drawings, in which:

FIG. 1 is a schematic sectional top view of a cryostorage unit according to an aspect of the present invention;

FIG. 2 is a cross-sectional view taken along line 2-2 of FIG. 1;

FIG. 3 is a cross-sectional view taken along line 3-3 of FIG. 1;

FIG. 4 is a top perspective view of a component of the cryostorage unit of FIG. 1;

FIG. 5 is an exploded perspective view of the component of FIG. 4;

FIG. 6 is a detail view of area “6” of FIG. 1;

FIG. 7 is a detail sectional side view of the cryostorage unit of FIG. 1;

FIG. 8 is a top perspective view of a component of the cryostorage unit of FIG. 1;

FIG. 9 is a bottom perspective view of the component of FIG. 8;

FIG. 10 is a top perspective view of a component of the cryostorage unit of FIG. 1;

FIG. 11 is a detail view of area “11” of FIG. 7;

FIG. 12 is a detail sectional side view of the cryostorage unit of FIG. 1;

FIG. 13A is a detail view of area “13” of FIG. 12, in a first configuration;

FIG. 13B is a detail view of area “13” of FIG. 12, in a second configuration;

FIG. 14 is a partial top perspective view of the cryostorage unit of FIG. 1 showing an alternate component configuration;

FIG. 15A is a schematic cross-sectional view of a component of the cryostorage unit of FIG. 1 in a first configuration;

FIG. 15B depicts the component of FIG. 15A in a second configuration;

FIG. 15C is a schematic bottom view of a component of FIG. 15A;

FIG. 15D is a schematic cross-sectional view taken along line “D-D” of FIG. 15C;

FIG. 15E is a schematic cross-sectional view taken along line “E-E” of FIG. 15C;

FIG. 16 is a schematic partial view of a system associated with the cryostorage unit of FIG. 1;

FIG. 17 is a flowchart schematically depicting an example scheme of operation of the system of FIG. 16;

FIG. 18 is a schematic top perspective view of a component related to the cryostorage unit of FIG. 1;

FIG. 19 is a schematic rear perspective view of the component of FIG. 18;

FIG. 20 is a top view of the component of FIG. 18;

FIG. 21 is an exploded top perspective view of the component of FIG. 18;

FIG. 22 is a schematic exploded top perspective view of a subassembly of the component of FIG. 18;

FIG. 23 is a schematic top perspective view of the subassembly of FIG. 18;

FIG. 24 is a schematic top perspective view of the subassembly of FIG. 18 in a first use configuration;

FIG. 25 is a schematic side view of the subassembly of FIG. 18 in the first use configuration of FIG. 24;

FIG. 26 is a schematic top perspective view of the subassembly of FIG. 18 in a second use configuration;

FIG. 27 is a flowchart schematically depicting an example scheme of operation of the component of FIG. 18;

FIG. 28 is a schematic top perspective view of a component related to the cryostorage unit of FIG. 1;

FIG. 29 is a bottom perspective view of the component of FIG. 28;

FIG. 30 is a top view of the component of FIG. 28; and

FIG. 31 is a side perspective view of the component of FIG. 28 in a first use configuration.

### DESCRIPTION OF ASPECTS OF THE DISCLOSURE

Unless defined otherwise, all technical and scientific terms used herein have the same meaning as is commonly understood by one of skill in the art to which the present disclosure pertains.

As used herein, the singular forms “a,” “an”, and “the” can include the plural forms as well, unless the context clearly indicates otherwise. It will be further understood that the terms “comprises” and/or “comprising,” as used herein, can specify the presence of stated features, steps, operations, elements, and/or components, but do not preclude the presence or addition of one or more other features, steps, operations, elements, components, and/or groups thereof.

As used herein, the term “and/or” can include any and all combinations of one or more of the associated listed items.

As used herein, phrases such as “between X and Y” and “between about X and Y” can be interpreted to include X and Y.

As used herein, phrases such as “from about X to Y” can mean “from about X to about Y.”

It will be understood that when an element is referred to as being “on,” “attached” to, “connected” to, “coupled” with, “contacting,” etc., another element, it can be directly on, attached to, connected to, coupled with, or contacting the other element, or intervening elements may also be present. In contrast, when an element is referred to as being, for example, “directly on,” “directly attached” to, “directly connected” to, “directly coupled” with, or “directly contacting” another element, there are no intervening elements present. It will also be appreciated by those of skill in the art that references to a structure or feature that is disposed “directly adjacent” another feature may have portions that overlap or underlie the adjacent feature, whereas a structure or feature that is disposed “adjacent” another feature might not have portions that overlap or underlie the adjacent feature.

As used herein, the phrase “at least one of X and Y” can be interpreted to include X, Y, or a combination of X and Y. For example, if an element is described as having at least one of X and Y, the element may, at a particular time, include X, Y, or a combination of X and Y, the selection of which could vary from time to time. In contrast, the phrase “at least one of X” can be interpreted to include one or more Xs.

As used herein, the term “medical professional” can refer to can refer to any clinician involved in medical care of a patient including, but not limited to, physicians, pharmacists, medical students, nurse practitioners, nurses, and technicians.

The invention comprises, consists of, or consists essentially of the following features, in any combination.

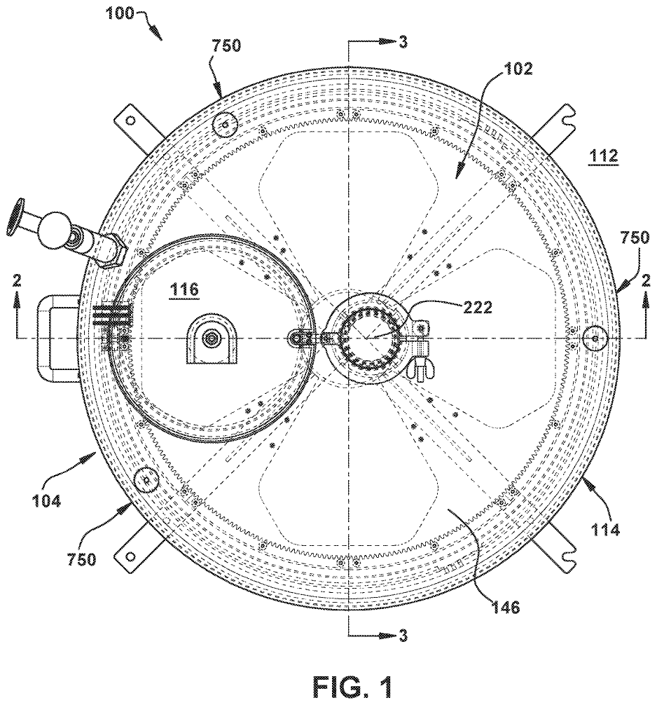

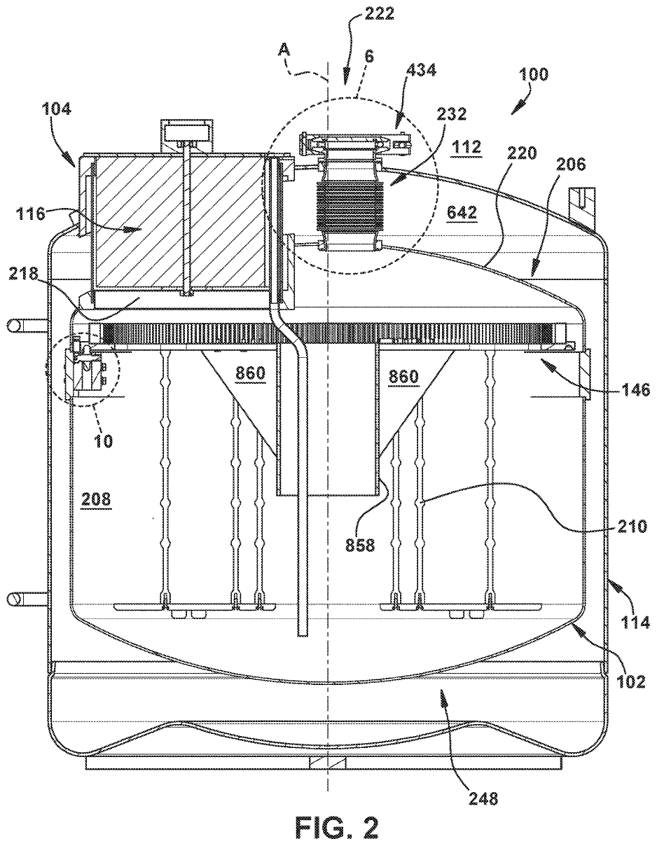

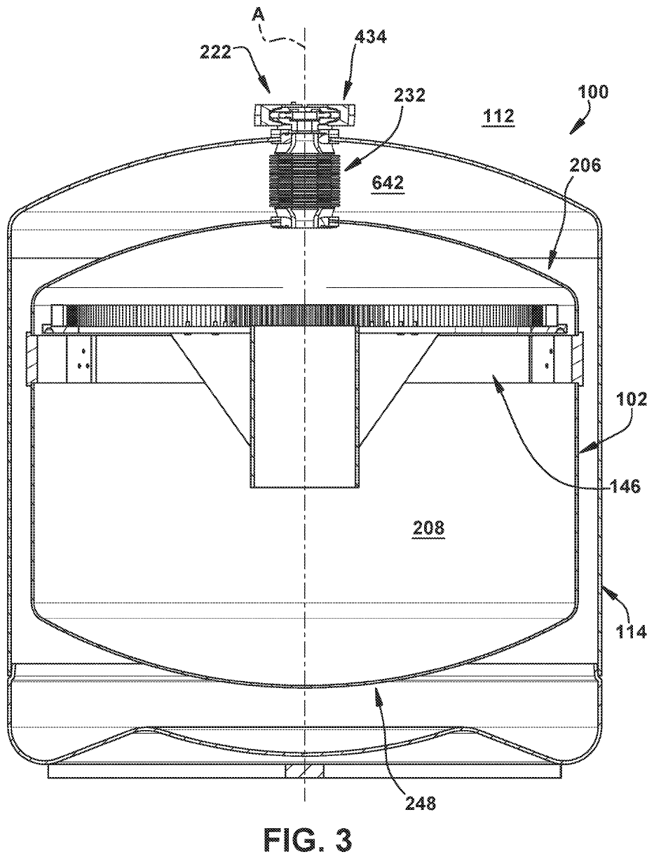

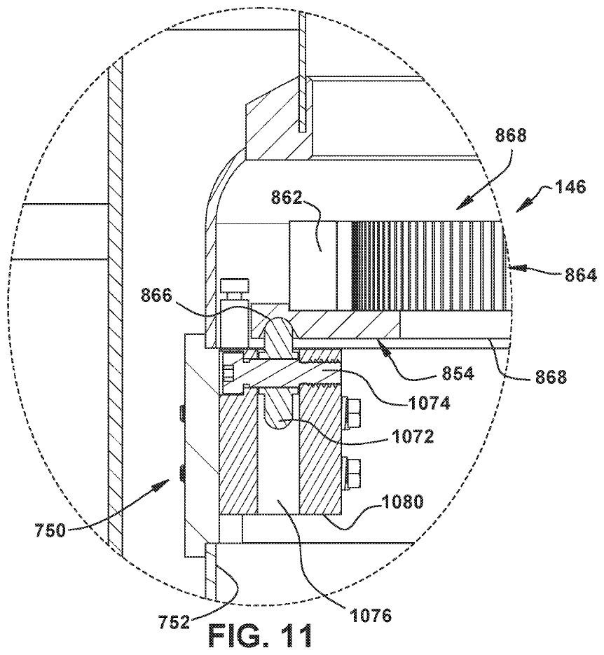

At least FIGS. 1-16 depict various aspects of a cryostorage unit 100, comprising a cryochamber 102 (e.g., a Dewar container) including a cryo-access port 104 at an upper portion 206 of the cryochamber 102. The “upper” and “lower” portions are longitudinally separated in the vertical direction, in the orientation of FIGS. 2-3. It should be understood that, in the present description, spatially relative terms, such as “under,” “below,” “lower,” “over,” “upper”, and the like, may be used herein for ease of description to describe one element or feature's relationship to another element(s) or feature(s) as illustrated in the figures. It will be understood that the spatially relative terms can encompass different orientations of a device in use or operation, in addition to the orientation depicted in the figures. For example, if a device in the figures is inverted, elements described as “under” or “beneath” other elements or features would then be oriented “over” the other elements or features.

FIG. 1 schematically depicts a plan view of the cryostorage unit 100 taken from above, and FIG. 2 schematically depicts an elevational view of the cryostorage unit 100 taken from the side. The cryostorage unit 100 may be of any desired type such as, but not limited to, the cryostorage unit and/or related components disclosed in the '834 patent.

The term “cryogenic” or the prefix “cryo” is used herein to reference a temperature which is below the reach of ordinary vapor-compression refrigeration—for example, below at least a portion of the range at which atmospheric gases (e.g., nitrogen, oxygen, argon, xenon) become liquid at normal pressures (−100° C. to −190° C.). Storage of certain biological materials below about −137° C., for example, may be desired in some use environments. For the sake of discussion, a “cryogenic” temperature is considered herein to be within a range lower than about −125° C. such as, for example, from about −125° C. to about −250° C., or from about −130° C. to about −145° C., or, more specifically, below or at about −137° C. A “range” can have two bounding values (e.g., from about −125° C. to about −250° C.) or a single explicit bounding value (e.g., below about −125° C., or below about −137° C.). The cryostorage unit 100 can be used in any setting where it is desirable to store material at cryogenic temperatures and selectively dispense the material. However, a pharmaceutical or biopharmaceutical use environment is provided here as an example.

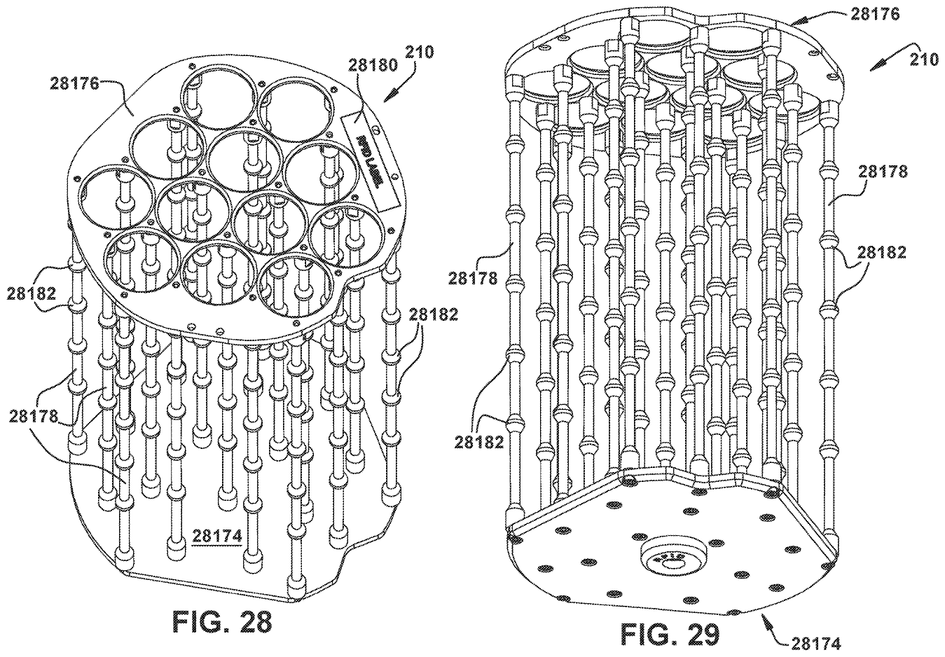

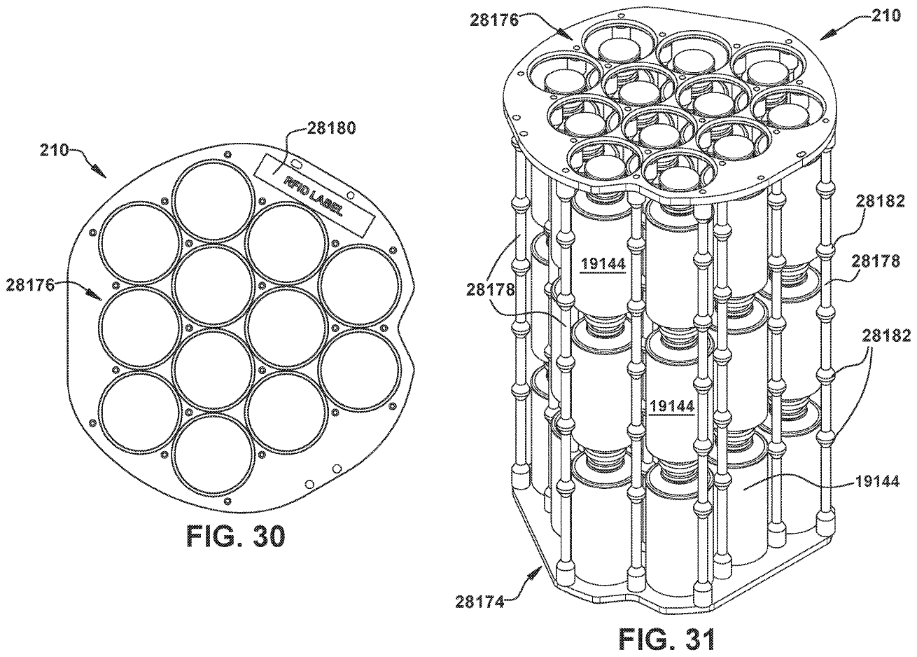

The cryochamber 102 defines an internal volume 208 substantially surrounding at least one rack 210, as will be discussed further with reference to FIGS. 28-31. The at least one rack 210 is configured to selectively support at least one container unit for cryogenically stored material. The container units could include one or more vials, bottles, cartridges, boxes, ampules, any other types of holders, and/or any combination of holders, and are configured to carry or contain materials including, but not limited to, medicines, drugs, therapeutic substances, cells, cell therapy based treatments, gene therapy based treatments, gene modified cell therapy based treatments or any other material(s) which are desirably stored at cryogenic temperatures, potentially with access control and monitoring. It is also contemplated that an individual container unit could be maintained in the cryochamber 102 without a surrounding rack 210 or other supporting structure; in such case, the container unit itself should be considered to be a rack 210, for the purpose of the present description.

The cryo-access port 104 is configured to selectively place an internal volume 208 of the cryochamber 102 in fluid communication with an ambient space 112 (a space or volume surrounding the cryochamber 102). A housing 114 may substantially surround the cryochamber 102 and selectively place the cryo-access port 104 into fluid communication with the ambient space 112. For example, the claimed cryochamber 102 could be placed within a mechanized dispenser type housing like that of the '834 patent, a manually accessed housing as known in the art, or employed in any other suitable use environment.

A cork 116 may selectively occlude the cryo-access port 104 for resisting ingress of ambient air to the cryochamber 102. The term “cork” is used herein in its ordinary usage within the cryocooling arts, to indicate a structure which fills, covers, stops-up, occludes or otherwise impedes fluid flow through or past a “corked” aperture or opening. A cork 116 may be partially, wholly, or not at all located within a plane of the structure being occluded. A cork 116, as referenced herein, may be made of any desired material or combination of materials, which may be chosen to have low thermal conductivity, and is not restricted to formation of natural or artificial plant tissue taken from (or based upon that taken from) the cork tree.

The cryo-access port 104, which is selectively occluded by the cork 116, is shown in at least FIG. 2 as including an aperture 218 extending through a top cryochamber surface 220. As depicted in FIG. 2, the aperture 218 is located non-coaxially with, and laterally offset from, a central vertical axis “A” of the cryochamber 102. The central vertical axis “A” defines a “longitudinal” direction, for the purposes of this description. The “lateral” direction, as referenced herein, is substantially perpendicular to the vertical axis “A”. It is contemplated that the aperture 218 could instead be substantially (at least partially or wholly) aligned with the central vertical axis “A”, extend through a different surface of the cryochamber 102, or otherwise be configured as desired for a particular use environment. The absence of the aperture 218 in FIG. 3 reflects the sectioning of that Figure occurring orthogonal to the section line defining FIG. 2 (see FIG. 1 for orientations).

The cooling agent may include an elongate heat exchanger 222 assembly at least partially suspended into the internal volume, a fluid coolant selectively directed into the internal volume 208, a fluid coolant located in a space between the housing 114 and the cryochamber 102, or any other desired cooling agent such as, but not limited to, one or more of open evaporative cooling (e.g., by provision of liquid nitrogen or another evaporative coolant), and a closed-loop refrigeration system where the refrigerant is circulated within a sealed heat exchanger inside the cryochamber and returned to an external heat rejection device. The external device may be, for example, a Stirling-cycle cooling engine, a vapor-compression refrigeration system, and/or any suitable heat-pumping means operative at the desired temperatures. The cooling agent may electrically and/or fluidically operate upon any desired part of the cryochamber 102 (including the interior volume 208 and/or a structure therein) to induce cryogenic temperatures as desired for a particular use environment. When the cooling agent includes an elongate heat exchanger 222, that heat exchanger may extend substantially coaxially with the central vertical axis A of the cryochamber 102, as shown in the Figures.

This heat exchanger 222 may be of the “cold finger”, umbrella, and/or partial disk type(s) or of any other desired active or passive configuration, including sealed heat pipes. As shown in FIG. 2, the heat exchanger 222 extends down into the interior volume 208 of the cryochamber 102 and facilitates convective flow of air within the cryochamber 102 to reduce thermal stratification of the interior of cryochamber 102 that may otherwise arise in a closed vessel of cold, still air. The convection flow may work to bring air warmed by heat leak into the cryochamber 102 (principally via its outer walls and access port) to the heat exchanger for re-cooling, without need of any mechanical circulator device (like a fan), which may be unreliable in such cold environments. One of ordinary skill in the art can readily provide any desired heat exchangers, cooling sources, or other cooling-related functions and components for the cryostorage unit 100, having any desired type, number, configuration, position, or other properties, to achieve desired results for particular use environment.

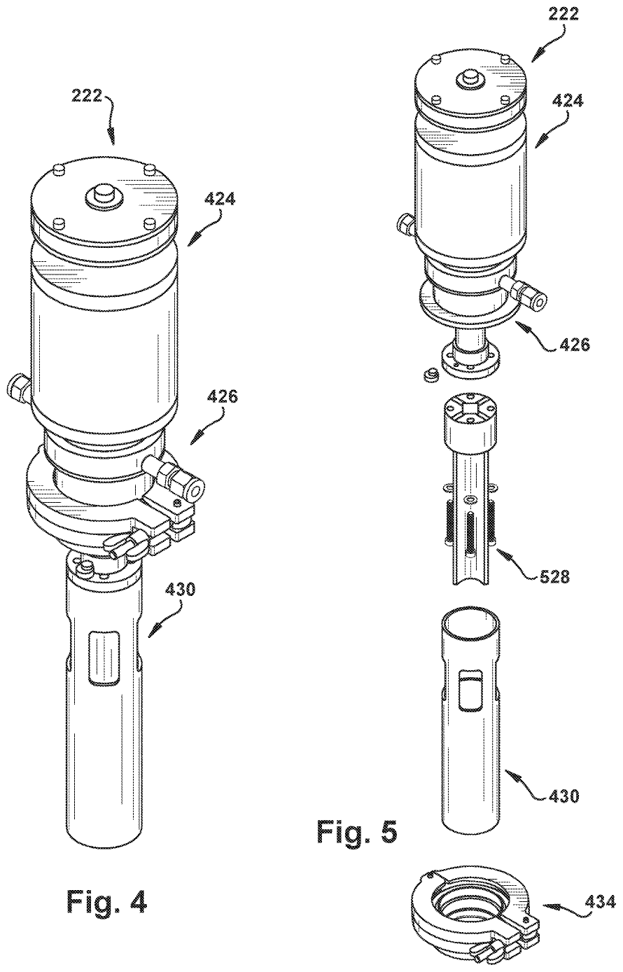

One example heat exchanger 222 is shown in FIGS. 4-5. The heat exchanger 222 is of a “cold finger” type (i.e., a conductive extension reaches into the cryochamber 102 from the chilled surface of the cooling engine) and may be used in conjunction with a Stirling engine 424, and/or a water jacket 426 for helping to transmit heat from the cryochamber 102 to the Stirling engine 424 from at least one conductive fin 528 (a plurality of copper fins are shown as an example in FIG. 5). The fin(s) 528 are held within a heat exchanger sleeve 430. Such placement of the fins 528 within the heat exchanger sleeve 430 may be used, for example, to protect the fin(s) 528 and/or for achieving desired thermal function by directing the warmest air within the cryochamber, that collects at its upper regions, into the heat exchanger 222 near a topmost portion thereof, and guiding that directed air, as it cools and densifies, to flow down toward the lower portions of the cryochamber 102 without immediately mixing with the surrounding warmer air; thereby establishing an ongoing convective circulation in the cryochamber 102 to bring heat to the heat exchanger for removal. This arrangement may also reduce thermal stratification in the cryochamber. The assembly of heat exchanger 222 and Stirling engine 424 is held in place within a heat exchanger dock (shown as 232 in FIG. 2) of the cryostorage unit 100 by a heat exchanger clamp 434.

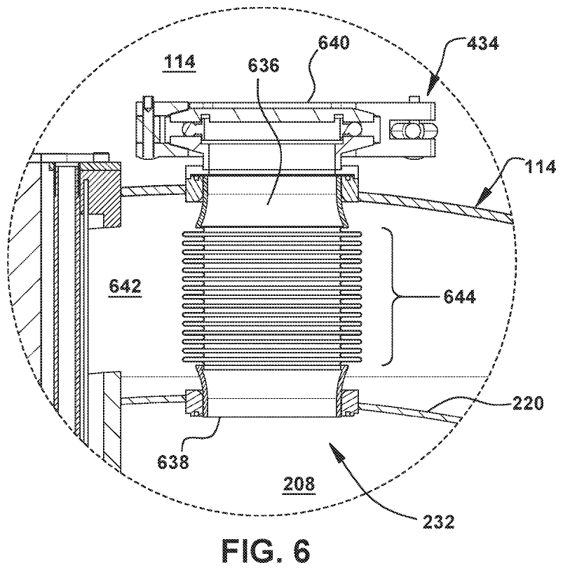

The heat exchanger dock 232 is shown without the heat exchanger 222, and in its place on the cryostorage unit 100 in the schematic detail view of FIG. 6. The heat exchanger dock 232 includes a throughpipe 636 having longitudinally separated inner and outer throughpipe ends 638, 640 which are fluidtightly sealed to the cryochamber 102 (as shown, top cryochamber surface 220) and to the housing 114, respectively. The throughpipe 636 accordingly provides a passageway (for insertion of the heat exchanger 222) between the ambient space 112 and the internal volume 208, while separating both of those spaces from an interstitial space 642 defined between the housing 114 and the cryochamber 102. As a result, the heat exchanger 222 can be inserted into, and removed from, the cryochamber 102 without accessing the interstitial space 642 (which may be held at low pressure, down to and including a vacuum state, to assist with insulation of the cryochamber 102). An outer circumferential wall of the throughpipe 636 within the interstitial space 642 may be provided with one or more throughpipe convolutions 644, of any desired configuration. These throughpipe convolutions 644 are shown in the Figures as extending circumferentially around the central opening within the throughpipe 636, but could be longitudinally oriented, spirally oriented, spike/point/stud style, and/or have any desired configuration for a particular use environment. When present, the throughpipe convolutions 644 may serve to extend the conductive path length along the throughpipe wall, which is operative to reduce conductive transmission of heat along the throughpipe wall, from the outside to the inside of the cryostorage unit 100.

With reference now to FIGS. 1-3, a carousel deck 146 may be located within the internal volume 208 of the cryochamber 102, optionally adjacent the cryo-access port 104. The carousel deck 146 may be located substantially above the at least one rack 210 and suspend the at least one rack 210 downward therefrom into the internal volume 208. (It is also contemplated that the carousel deck 146 may be located toward a lower portion 248 of the cryochamber 102 and support at least one rack 210 from beneath, and one of ordinary skill in the art can readily reconfigure a cryostorage unit 100, as described herein as having the “top-mounted” carousel deck 146, for a particular bottom-mounted use environment.)

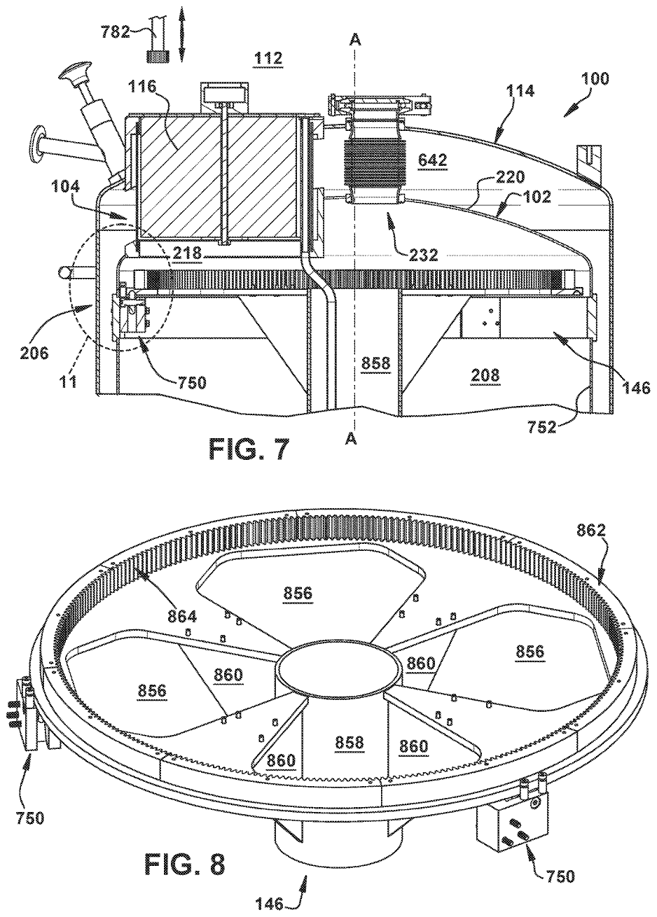

Turning to FIG. 7, the carousel deck 146 is shown within the cryochamber 102 in detail. The carousel deck 146 may engage with at least one carousel bearing 750 located in the internal volume 208. The at least one carousel bearing 750, when present, may substantially support the carousel deck 146 with respect to an inner surface 752 of the cryochamber 102 for rotational motion relative to the cryochamber 102. The at least one carousel bearing 750 may be configured for slidable and/or rotational engagement with the carousel deck 146. The carousel deck 146 rotates substantially horizontally within the cryochamber 102. The at least one carousel bearing 750 may be connected (directly or indirectly) to the inner surface 752 (i.e., inner wall) of the cryochamber 102 adjacent the upper portion 206 thereof. It is contemplated, though, that the carousel bearing 750 may be suspended from the upper portion 206 of the cryochamber 102, supported from the lower portion 248 of the cryochamber 102, or otherwise provided to the cryostorage unit 100. Suitably configured carousel bearings could be carried by the carousel deck 146 for rolling and/or slidable engagement with a rail or other feature on nan inner wall of the cryochamber 102. Any desired number of carousel bearings 750, having any desired material(s), configuration, structure, location(s), or other physical characteristics, may be provided to the cryostorage unit 100, and may be readily configured by one of ordinary skill in the art for a particular use environment. Here, three carousel bearings 750 are shown, spaced substantially equidistant from one another (as shown in FIG. 1) about an inner circumference of the cryochamber 102 for reasons such as, but not limited to, control of rolling resistance, self-leveling of the carousel deck 146, desired braking friction, ease of assembly/repair, and/or manufacturing cost control.

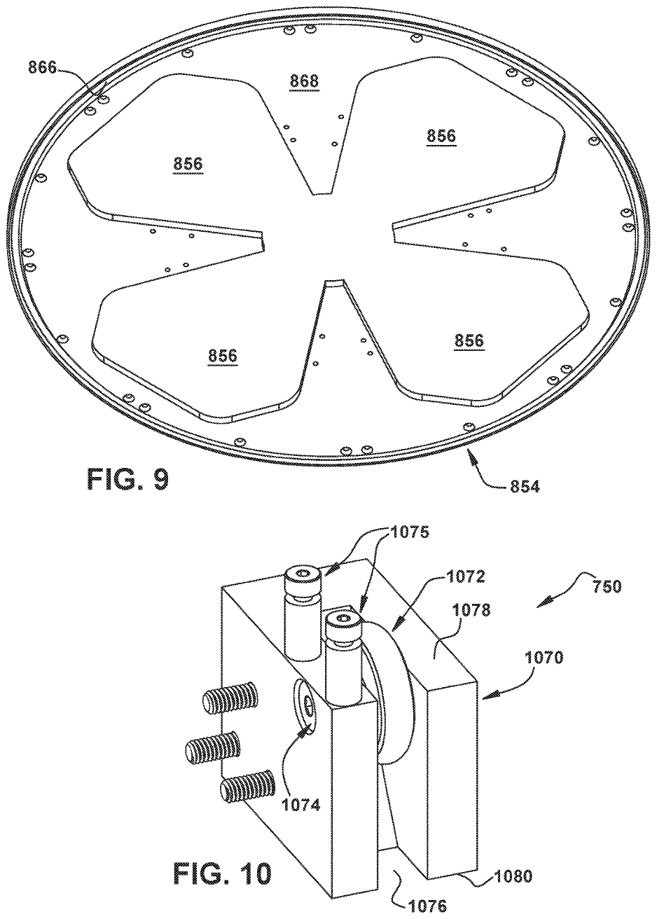

The carousel deck 146 is shown in further detail in the top view of FIG. 8 (with the carousel bearings 750 included) and in the partial bottom view of FIG. 9 (without the carousel bearings). In FIG. 8, the structure of the carousel deck 146 is shown as including a substantially planar carousel disk 854, including a plurality of rack apertures 856 for insertion therethrough of at least one container rack 210, as will be discussed further with reference to FIGS. 28-31, below. Any desired number, location, size, shape, and type of rack apertures 856, or any other structure or void, may be provided as desired to facilitate access through the carousel disk 854 (in the top-mounted system shown in the Figures) to underlying materials being cryogenically stored in the cryostorage unit 100. Here, the rack apertures 856 are substantially equally spaced, in rotational symmetry, upon the carousel disk 854, which may be helpful with balancing of the carousel disk 854.

In the configuration of the carousel deck 146 shown in the Figures, a carousel hub 858 is shown as being substantially coaxial with the vertical axis A, with a plurality of carousel fins 860 extending longitudinally between an outer cylindrical surface of the carousel hub 858 and “spoke” areas of the carousel disk 854. The carousel fins 860, when present, may help provide a “bracing” or load-transferring function to assist with maintaining the planar nature of the carousel disk 854 under load. A carousel rim 862 extends longitudinally upward from an upper surface of the carousel disk 854 and may include an edge feature 864 to assist with rotating the carousel deck 146 as described below.

At least one of a lower and an upper surface of the carousel deck 146 may include a groove 866 for rotational support of the carousel deck by at least a portion of the carousel bearing 750. With reference to FIG. 9., a lower surface 968 of the carousel disk 854 is shown as including the groove 866, which may be configured as desired for interaction with the carousel bearing 750. FIG. 9 also shows the manner in which the individual rack apertures 854 can be formed as a single, integrated cut-out, which the carousel hub 858 then separates into individual “stations” for selectively accepting racks 210.

FIG. 10 depicts an example carousel bearing 750 which may be used with the cryostorage unit 100. The at least one carousel bearing 750 may include an axle frame 1070 carrying a rotatable wheel 1072 (which is rotatable about an axle 1074 carried by the axle frame 1070). The axle frame 1070 may be, in some example implementations as previously noted, connected to the inner surface 752 of the cryochamber 102. The rotatable wheel 1072 is maintained in rotational contact with the carousel deck 146, and more particularly in some use environments, in rotational contact with the groove 866 for rotational support of the carousel deck 146. The carousel bearing 750 may be mounted to the inner surface 752 of the cryochamber 102 (or another mounting point, for a particular use environment) in any suitable manner, such as via the bolted connection shown in the Figures. At least one roller 1075 having an axis substantially parallel to the carousel rotational axis may be provided on at least one bearing mount 750, proximate to an outer edge of the carousel deck 146 and optionally proximate to the engagement of actuator revolver 782 with carousel deck 146, to resist undesirable radial movement of carousel 146 due to forces applied by actuator revolver 782.

As is apparent from at least FIG. 10, the axle frame 1070 may hold the rotatable wheel 1072 in a C-slot 1076 of the axle frame. As shown in the Figures, the axle frame 1070 may be mounted on the inner surface 752 of the cryochamber 102 with the C-slot 1076 being open on upper and lower longitudinally separated surfaces 1078 and 1080, respectively, of the axle frame 1070. When the C-slot 1076 is provided and oriented as shown, any frost buildup on the rotatable wheel 1072 or other components of the carousel bearing 750 may more easily fall toward the lower portion 248 of the cryochamber 102, thus resisting ice buildup on the carousel bearing 750 components.

It is contemplated that the carousel bearing 750 may be of an “active” type, which is powered for driving contact with the carousel deck 146 in some use environments, though the depicted arrangement includes passive carousel bearings 750 which simply support the carousel deck 146 and facilitate rotational motion thereof. With either active or passive carousel bearings 750, a drive unit may be located substantially within the internal volume (permanently or as-needed) for inducing rotational motion of the carousel deck 146. As noted, the drive unit, when present, may comprise an active-type driven carousel bearing 750 wheel or other structure which resides permanently within the cryochamber 102. Another example of a suitable drive unit—this one temporarily located within the cryochamber 102 as-needed—is the actuator revolver 782 shown schematically in FIG. 7. This actuator revolver 782, when present, may be similar to that shown and described in the '834 patent.

The actuator revolver 782, when present, is configured for selective insertion through the cryo-access port 104 from an ambient space 112 to induce rotational motion of the carousel deck 146. For example, the actuator revolver 782 may drive an edge feature 864 of the carousel deck 146 to induce rotational motion thereof. As shown in the Figures, the edge feature 864 may be a toothed rim, with which a correspondingly toothed actuator revolver 782 may engage in a toothed-gear type manner. It is contemplated that a frictional-engagement, peg/hole, or other edge feature 864 could be provided to the carousel deck 146 as desired to facilitate driving thereof by the actuator revolver 782 or any other prime mover.

When the rotational position of the actuator revolver 782 is suitably monitored, the toothed rim type edge feature 864 may be helpful in indexing a rotational position of the carousel deck 146 and, by extension, any rack 210 associated therewith. The carousel deck 146, however, may be rotated in any desired manner. The actuator revolver 782 could be helpful in situations when it is desirable to avoid taking up space within the cryochamber 102 and/or subjecting relatively delicate motion-producing machinery to the cryogenic temperatures within the cryochamber 102, other than as appropriate to move the carousel deck 146 during the active retrieval of a chosen container unit, as described below. The actuator revolver 782 could interface with a feature of the carousel deck 146 to selectively rotate the carousel deck 146 within the cryochamber 102, optionally with the assistance of an axle, gear train, or other structure to assist with alignment and/or smooth movement.

One of ordinary skill in the art could readily provide a scheme for rotating or otherwise moving the carousel deck 146 for a particular use environment. The actuator revolver 782 shown and described herein, acting through the cryo-access port 104 via selective insertion therethrough, may assist with reducing or eliminating heat leak from the cryochamber 102 otherwise associated with a permanent internal actuator and gives enhanced angular location precision by use of the very large ring gear (toothed carousel rim 862) rather than a central shaft as known in the art, for certain use environments.

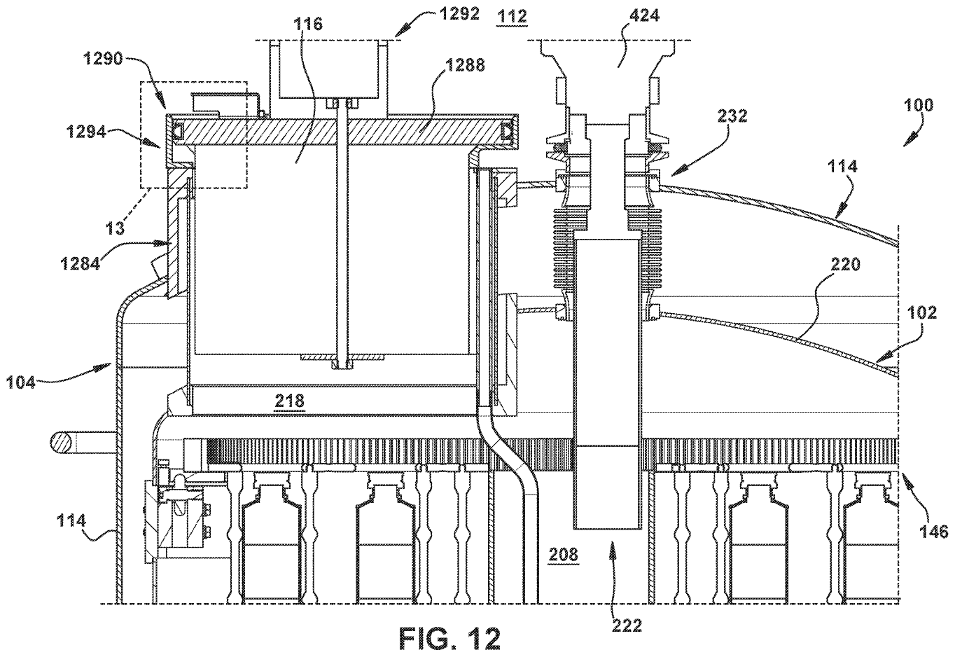

Turning now to FIGS. 12-14, the cork 116 and cryo-access port 104 relationship will be discussed in detail, particularly as pertains to achieving desired “sealing” of the aperture 218 to avoid unwanted heat and/or fluidic incursion into the cryochamber 102 from the ambient space 112. As shown in at least FIG. 12, the cryo-access port 104 is configured to place the internal volume 208 in fluid communication with the ambient space 112 via the port aperture 218 extending through the top cryochamber surface 220. The cryo-access port 104 is at least partially defined by a port collar 1284 which is in fluid communication with the port aperture 218 and which extends longitudinally upward beyond the upper portion of the cryochamber 102. The cork 116 selectively occludes the cryo-access port 104 for resisting ingress of ambient air to the cryochamber 102.

The cork 116 includes a lower cork body 1286 having a first cross-sectional footprint and configured for selective nesting engagement within the port collar 1284. The term “selective nesting engagement” is used herein to indicate a situation in which one of the cork 116 and the port collar 1284 fits into the other of the cork 116 and the port collar 1284, in a mating or matched-profile arrangement. There may be an interference or frictional engagement between these two structures, or the nesting engagement could merely be a close matching of profiles which admits of some degree of separation at least partially therebetween. The cork 116 and at least a portion of the cryo-access port 104 (e.g., the port collar 1284), for example, may both be substantially circular in lateral cross-section, or may have any other desired footprint or shape.

The cork 116 includes an upper lid 1288 including an upper lid feature 1290 having a second cross-sectional footprint, which is larger in at least one dimension than the first cross-sectional footprint of the lower cork body 1286. As shown in the Figures, the upper lid feature 1290 has a larger diameter than does the lower cork body 1286, but one of ordinary skill in the art could readily provide a suitably configured upper lid feature 1294 a particular use environment. An engagement handle 1292 may be provided to the upper lid 1288 or to any other desired portion of the cork 116, to facilitate removal of the cork 116 from the port collar 1284. At least a portion of the port collar 1284 may include a cork seat feature 1294 configured for selective engagement with at least a portion of the upper lid feature 1290 to resist travel of fluid along a longitudinal fluid path between the cork 116 and the port collar 1284. The upper lid feature 1290, when present, may be configured for a selective interference, or frictional, fit with the cork seat feature 1294.

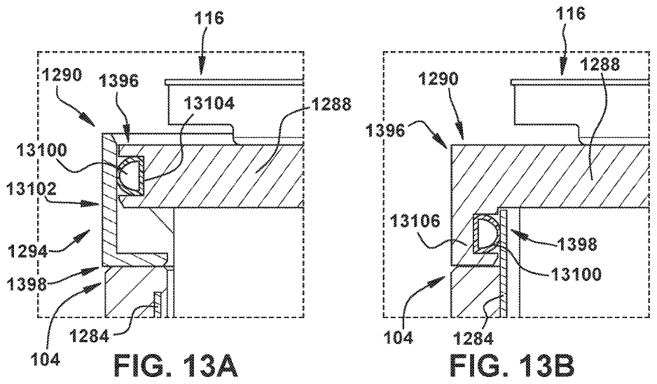

FIGS. 13A-13B depict optional alternate configurations of the region shown as area “13” in FIG. 12. The arrangement of FIG. 13A is substantially similar to the existing situation in FIG. 12. Namely, the upper lid feature 1290 includes a protruding rim 1396 and the cork seat feature 1294 includes an increased-footprint seat lip 1398 at an upper portion of the port collar 1284. At least a portion of the protruding rim 1396 selectively rests upon the seat lip 1398 (see, e.g., the right side of the cork 116, as shown in FIG. 12) as the cork 116 is nested into the port collar 1284, to resist travel of fluid between the cryogenic interior volume 28 and the ambient space 112. A resilient sealing element 13100 may be carried by at least a selected one of the protruding rim 1396 and the seat lip 1398. When present, at least a portion of the sealing element 13100 may be interposed vertically between the protruding rim 1396 and the seat lip 1398 when the cork 116 is nested into the port collar 1284. With reference again to FIG. 13A, the cork seat feature 1294 may include a vertically extending seat wall 13102 protruding upward from the seat lip 1398. The seat wall 13102 laterally surrounds at least a portion of an outer perimeter of the protruding rim 1396.

When a seat wall 13102 is present, at least a chosen one of the seat wall 13102 and the protruding rim 1396 may include a resilient sealing element 13100 on a laterally-facing surface thereof, for sealing against the other one of the seat wall 13102 and the protruding rim 1396. As shown in FIG. 13A, the chosen one of the seat wall 13102 and the protruding rim 1396 may include a laterally-extending groove 13104 for maintaining at least a portion of the sealing element 13102 therein.

As shown in FIG. 13B, as another option for the cork 116 and cryo-access port 104 interface, the protruding rim 1396 may include an overhanging wall 13106 extending vertically downward from an outer perimeter thereof. The overhanging wall 13106, when present, may laterally surround at least a portion of an outer perimeter of the seat lip 1398. At least a chosen one of the overhanging wall 13106 and the protruding rim 1396 may include a resilient sealing element 13100 on a laterally-facing surface thereof, for sealing against the other one of the overhanging wall 13106 and the protruding rim 1396. Alternatively or additionally, a face seal may be used between lid 1288 and port collar 1284, comprising a suitable resilient seal therebetween when the cork 116 is in place in the port 218.

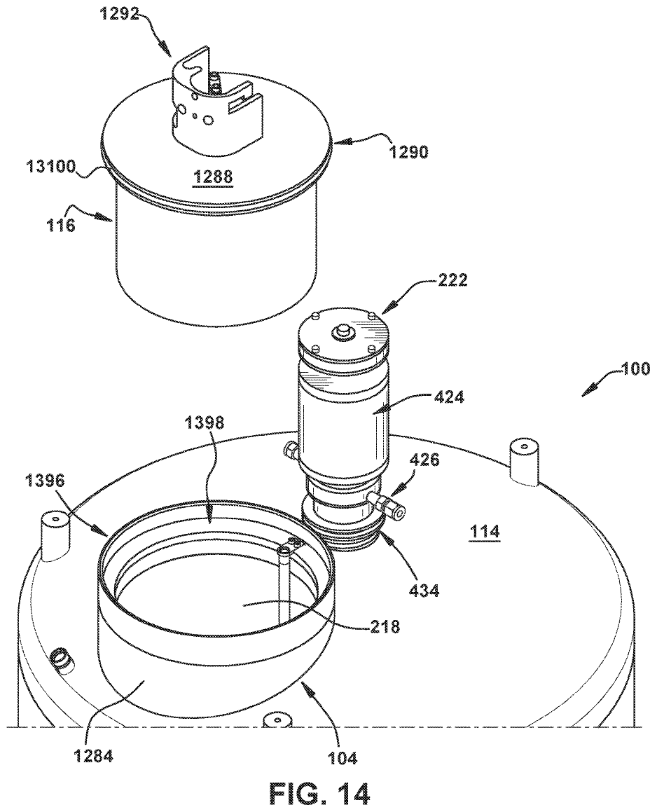

FIG. 14 is an exploded view depicting the cork 116 removed from the port collar 1284, and showing the “ledge” type cork seat feature 1294 of FIG. 13A. One of ordinary skill in the art will be readily able to provide a suitably configured cork 116 for at least partially sealing the cryo-access port 104 as desired for a particular use environment.

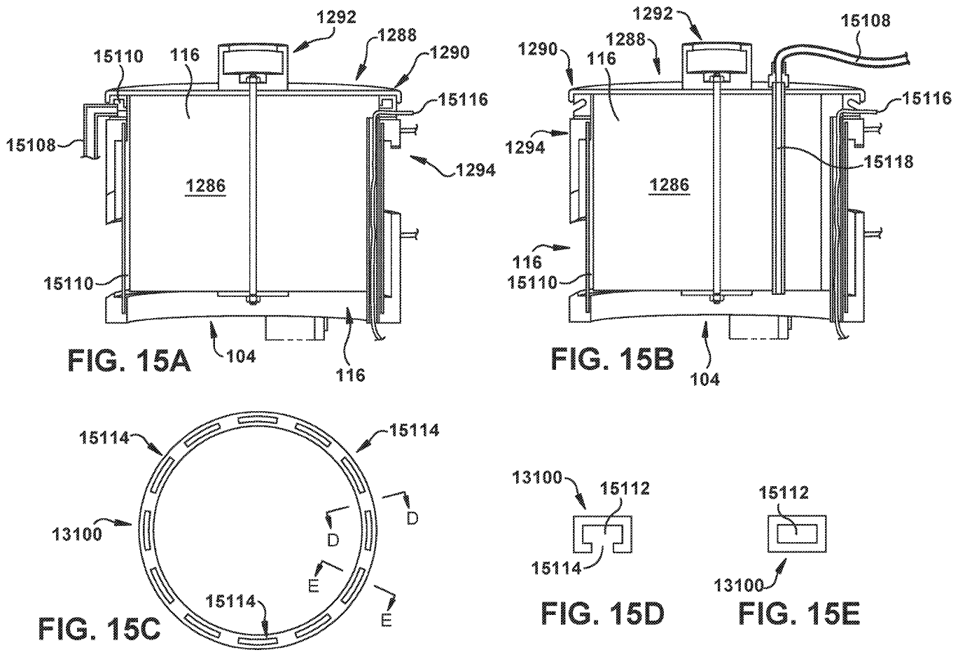

In addition to a sealing function, the cork 116, cryo-access port 104, and/or other features of the cryostorage unit 100 may be provided with structures and features operative to assist with maintaining desired dry air within the cryochamber 102. Several such provisions will be described below with reference to FIGS. 15A-17.

As a preliminary note to this portion of the disclosure, it is worth exploring how dry “dry air” is and at what temperatures it contains how much moisture, since known commercially available dryers cannot reach the level of dryness associated with many cryogenic storage temperatures of a cryostorage unit 100 (approximately −150° C., in many use environments). Dryness is best described by “dewpoint”—i.e., the temperature of moisture-bearing air at which that moisture begins to condense out (also called saturation temperature and corresponding to 100% relative humidity for that temperature). Commercial compressed-air dryers typically achieve dewpoints of −40° F. (~−40° C.), though −100° F. is possible. It should be considered how much reduction in moisture content this represents, compared to 100% relative humidity at 20° C., about twice typical conditioned indoor air quality (50% RH). This is readily compared by examining the partial pressure, P, of water saturation in atmospheric air (at 100 kPa=1 bar) in Table 1, below:

| Temperature | | Partial Pressure (P) | | vs. Ambient | |
|---|---|---|---|---|---|
| 20° C. | (293 K) | 2.37 | kPa | 100% | (0% reduction) |
| 0° C. | (273 K) | 0.61 | kPa | 25.8% | (74.2% less) |
| −40° C. | (253 K) | 0.02 | kPa | 0.9% | (99.1% less) |
| −100° C. | (173 K) | 0.000006 | kPa | 0.14% | (99.86% less) |
| −150° C. | (123 K) | 1.8E−11 | kPa | ~0% | (~100% less) |
| −173° C. | (100 K) | 7.3E−16 | kPa | ~0% | (~100% less) |

It can accordingly be noted that even lowering the dewpoint to −40° C. removes over 99% of ambient moisture content (~98%, if compared to 50% RH air instead of saturated 20° C. air). As excessive icing can be problematic for the maintenance and operation of a cryostorage unit 100 in the field, it can be seen that reducing the airborne moisture inside the internal volume 208 can be quite helpful in maintaining desired non-iced conditions within the cryochamber 102. One of ordinary skill in the art will be able to provide a suitable scheme for supplying dry air to the internal volume 208 for a particular use environment of the cryostorage unit 100. Examples of such schemes are given in FIGS. 15A-17.

With reference first to FIG. 15A, an external dry air supply line 15108 may be placed in fluid-supplying communication with a ventilation space 15110 located laterally between the cork 116 and the port collar 1284. In this way, dry air may be “injected” into the cryo-access port 104 at the interface between the cork 116 and the port collar 1284. FIGS. 15C-15E schematically depict a bottom view of a sealing element 13100, which is interposed between the cork seat feature 1294 and the upper lid feature 1290 and includes a center channel 15112 for dispensing dry air from the dry air supply line 15108 toward the ventilation space 15110. Cross-sections (FIGS. 15D-15E) are also provided to show the center channel 15112 of the resilient sealing element 13100, which can be placed in fluid communication with the dry air supply line 15108 for directing fluid from the dry air supply line 15108 within the body of the sealing element 13100 for release, via manifold apertures 15114, into the ventilation space 15110 laterally between the cork 116 and the port collar 1284. (FIGS. 15A-15B also show the sealing element 13100 as including a sensor lead 15 116 passing therethrough, such as, but not limited to, for providing electrical connection between a humidity and/or temperature sensor within the internal volume 208 and an externally located computing device (not shown).

Another option for supplying dry air to the internal volume 208 is shown in FIG. 15B. Simply, the lower cork body 1286 includes a dry air channel 15118 extending vertically therethrough. The dry air channel 15118 is configured to place an external dry air supply line 15108 into fluid communication with the cryogenic interior volume 208.

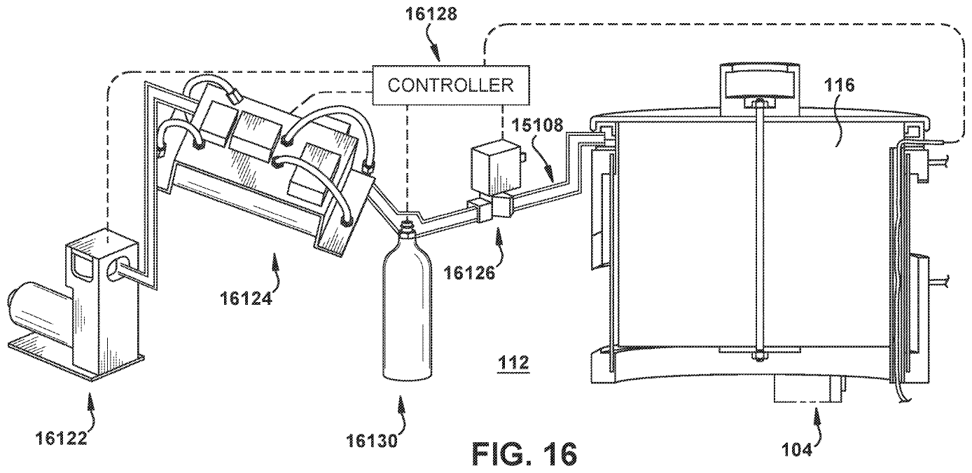

Regardless of whether the dry air is supplied to the ventilation space 15110 and/or the internal volume 208 using the example configurations of FIGS. 15A-15E and/or any other fluid-supplying structure and/or scheme, the active dry air supply device 16120 shown schematically in FIG. 16 could be used to selectively provide dry air to the internal volume 208, via a dry air supply line 15108 or in any other suitable manner. In FIG. 16, the manifold type sealing element 13100 of FIGS. 15A and 15C-E is shown as an example for distributing dry air to the ventilation space 15110, for use with the cryostorage unit 100 previously described. It is contemplated that the dry air supply device 16 120 could be used with a cork 116 having any desired configuration, such as, but not limited to, the optional configurations shown in FIGS. 12-14.

The dry air supply device 16120 includes a dry air supply line 15108 in fluid communication with at least a chosen one of the cryogenic internal volume 208 and the cryo-access port 104. The dry air supply device 16120 selectively provides dry air to volumetrically prevent intrusion of non-dry air within the chosen one of the cryogenic internal volume 208 and the cryo-access port 104. Per the above discussion, the dry air may have, for example, a dewpoint at or below −40° C.

The dry air supply device 16120 may include a pump 16122 for compressing ambient air, and a dryer 16124 for accepting the compressed ambient air from the pump 16122 and removing moisture from the compressed ambient air to produce dry air for routing to the dry air supply line 15108. A throttle 16126 may be in fluid communication with the dry air supply line 15 108 for selectively changing a rate of dry air flowing therethrough to the cryogenic internal volume 208.

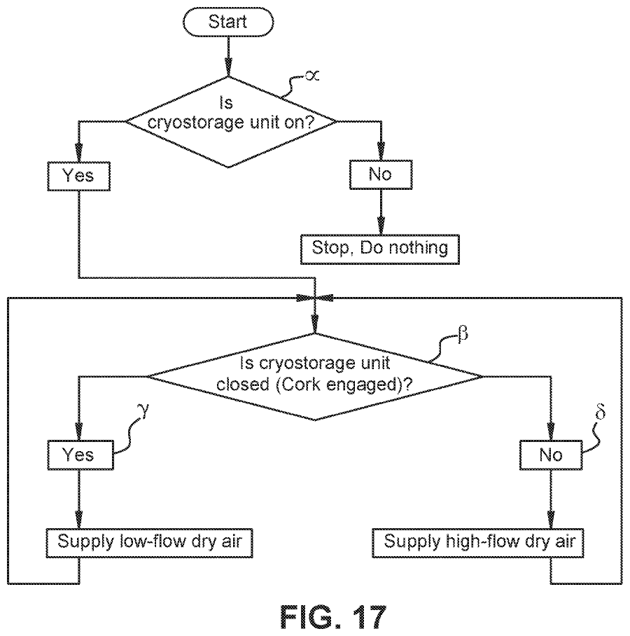

A controller 16128 may be in wired or wireless electrical communication with any other component of the dry air supply device 16120, for controlling provision of dry air to the cryostorage unit 100, via the dry air supply line 15108. These connections are shown schematically in FIG. 16, and operation of the controller 6128 may be carried out according to the flowchart of FIG. 17, which will be discussed below.

In summary, the throttle 16126 is configured to selectively change a rate of dry air flowing through the dry air supply line 15108 responsive to any desired input(s), such as, but not limited to, a physical condition of air in the ambient space 112, passage of a predetermined length of time, a physical condition or position of at least one component of the cryostorage unit 100, and/or a sensed condition within the chosen one of the cryogenic internal volume 208 and the cryo-access port 104. (As used herein, the term “rate” should be considered to encompass pressure, volume, quantity, flow speed, or any other quality of the dry air related to its supply through the dry air supply line 15108 and controllable by the throttle 16126.) For example, and in some use environments, the throttle 16126 could direct a predetermined rate of dry air flowing through the dry air supply line responsive to a sensed position of the cork 116 (e.g., seated, absent, or partially removed) relative to the port collar 1284.

It may be desirable, for example, for an increased rate of dry air to be provided through the dry air supply line 15108 when the cork 116 has been selectively removed from the cryo-access port 104 and/or for a predetermined period of time after the cork 116 is returned to a “closed position” sealing status in conjunction with the cryo-access port 104. It is also contemplated that at least a portion of dry air from the dry air supply device 16120 could be provided directly to the cryo-access port 104, regardless of presence or absence of the cork 116, for any desired reason, such as, but not limited to, maintaining a “positive pressure” within at least a portion of the cryochamber 102 and thereby resisting incursion of relatively moist air from the ambient space 112 when the cork 116 is selectively removed from the cryo-access port 104.

As shown in FIG. 16, the dry air supply device 16120 may include a buffer tank 16130 interposed fluidically between the dryer 16124 and the throttle 16126. When present, the buffer tank 16130 may facilitate selective variability of a quantity of dry air traveling through the dry air supply line 15108. The buffer tank 16130 may be of any desired configuration for a particular use environment and may be used to “bank” dry air from the pump 16122 via the dryer 16124, optionally under pressure, for later release into the dry air supply line 15108.

The dry air supply device 16120 can be used to supply either low- or high-flow dry air to a cryo-chamber 102 of a cryostorage unit 100 in accordance with, for some example use environments, the logic summarized in the flowchart of FIG. 17. In decision block a, the on/off state of the cryostorage unit 100 is determined. If the cryostorage unit 100 is off, nothing further is done. If the cryostorage unit 100 is on, control proceeds to decision block B, at which the open/closed status of the cryostorage unit 100 is determined. (For example, an engagement status of the cork 116 with the cryo-access port 104 can be checked to determine whether the cryostorage unit 100 is “closed”—i.e., whether the cork 116 is occluding the aperture 218.)

If the cryostorage unit 100 is closed, control of the FIG. 17 flowchart proceeds to block y, and low-flow dry air is supplied through the dry air supply line 15 108. Presuming that the cryostorage unit 100 is still on, control then returns to decision block B, to loop around in continued monitoring of the open/closed state of the cryostorage unit 100. Conversely, if the cryostorage unit 100 is not closed, control proceeds to block o, and high-flow dry air is supplied through the dry air supply line 15108. Presuming that the cryostorage unit 100 is still on, control then returns once again to decision block B, to loop around in continued monitoring of the open/closed state of the cryostorage unit 100. In this context, “low-flow” is a flow rate which may be sufficient to keep the internal volume 208 pressure above the local atmospheric pressure, may be potentially intermittent, and/or may be zero, in some embodiments. “High-flow” is used herein to indicate a flow rate which is enough to resist incursion of ambient air from the ambient space 112 into the cryochamber 102 through the cryo-access port 104, while cork 116 is being removed or port 104 is open. When cork 116 is occluding the access port 104, internal pressure in volume 208 may be held to about 5-20 Pascal (approximately 0.02 to 0.08 inches of water column) above local ambient pressure, as is typical in clean rooms where dust intrusion must be prevented—a situation similar to the moisture exclusion condition here under low-flow conditions. For example, 10 Pascal overpressure, acting on a cork 116 with an 8-inch seal diameter (about 22 cm) and an area of about 0.038 square meters, would produce an uplift force of about 0.38 Newtons. A cork 116 may have a mass of about 1 kilogram, and so feel a gravity force of about 9.8 Newtons; and the internal overpressure will not be sufficient to lift the cork 116 from a corresponding seal; so the flow required will be near zero, according to any leakage through the seal.

During removal of cork 116, a high flow, similar to or greater than the volume removal rate of the cork, may be used to replace the removed cork volume with dry air, rather than allowing moist ambient air to enter, drawn by the suction that would otherwise arise by the removal of the cork 116. High flow for a cork 116 of diameter and length of 8 inches (0.22 m) and extracted over a period of 2 seconds (for example) would require a replacement volume flow rate of about at least 0.004 cubic meters per second (approximately 9 cubic feet per minute). Both low- and high-flow may be provided by one or more of: increasing pressure or power of the pump 16122, opening a restriction in the dry air supply line 15108 (such as, but not limited to, opening the throttle 16126), releasing additional stored dry air from the buffer tank 16130, or any other desired flow control action or scheme.

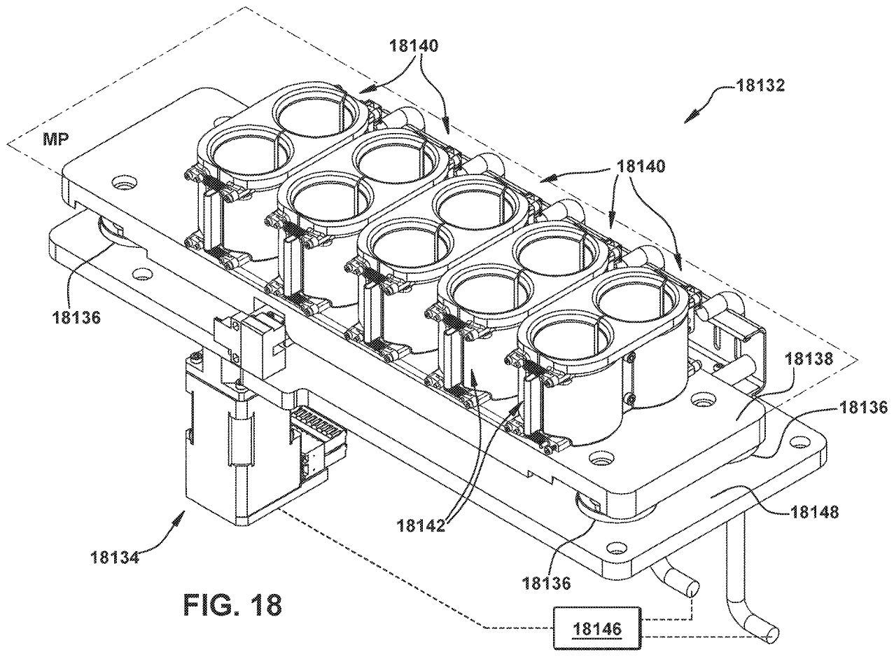

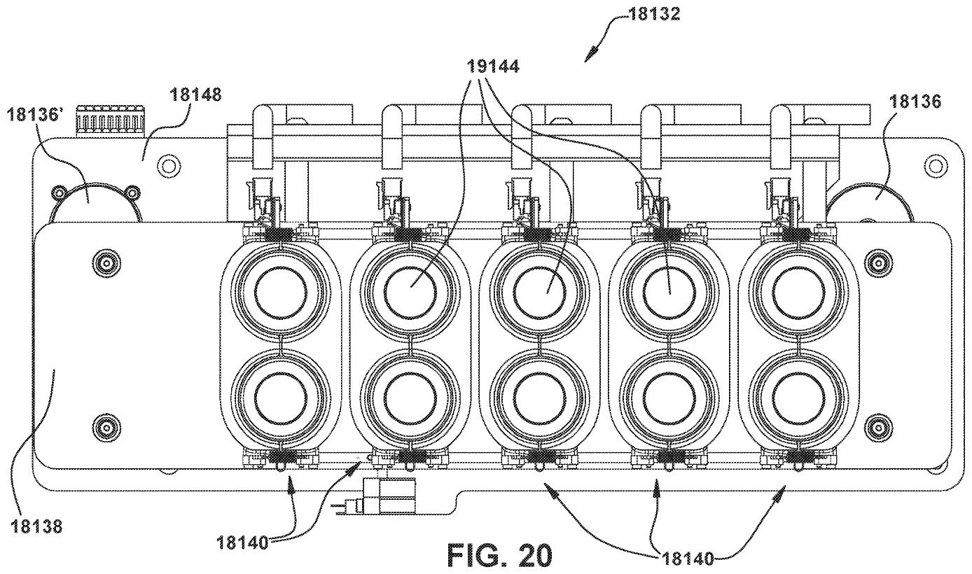

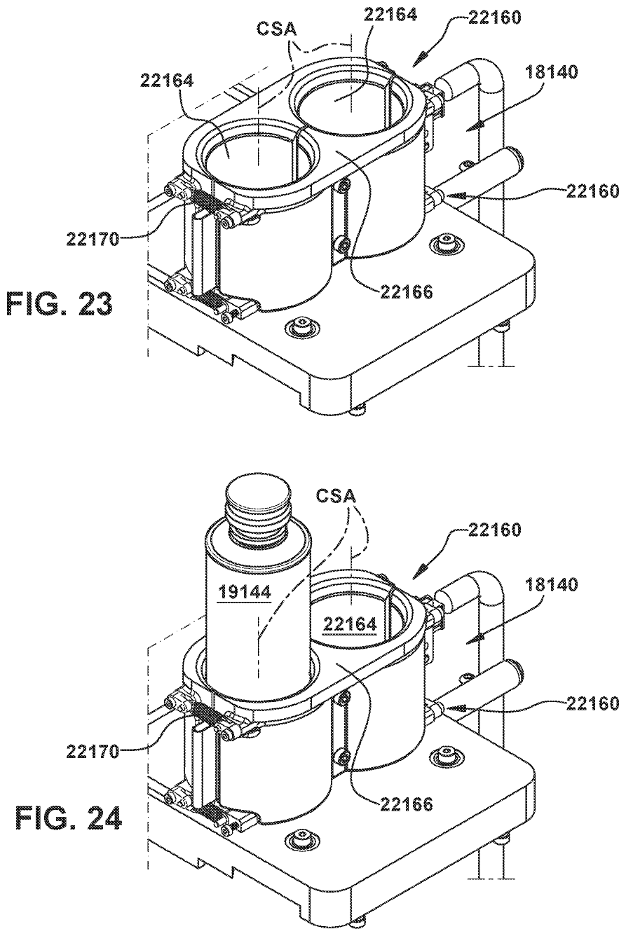

FIGS. 18-27 schematically depict a material thawing device 18132 which can be used in conjunction with the container units which are selectively stored in the cryostorage unit 100. For convenience, the device of FIGS. 18-27 is described as being used for “thawing” materials, but it is contemplated that one of ordinary skill in the art could readily provide a device, according to the principles taught herein, for use in any desired application in which material is subjected to addition or extraction of heat, change of phase (e,g, solid-to-liquid or vice versa), a positive or negative temperature change, application of a flat-plane motion, or any other desired material handling and/or treatment task. One of ordinary skill in the art will be readily able to correlate and adjust the terms used in the below description for the intended application, if such does not include “thawing”, per se.

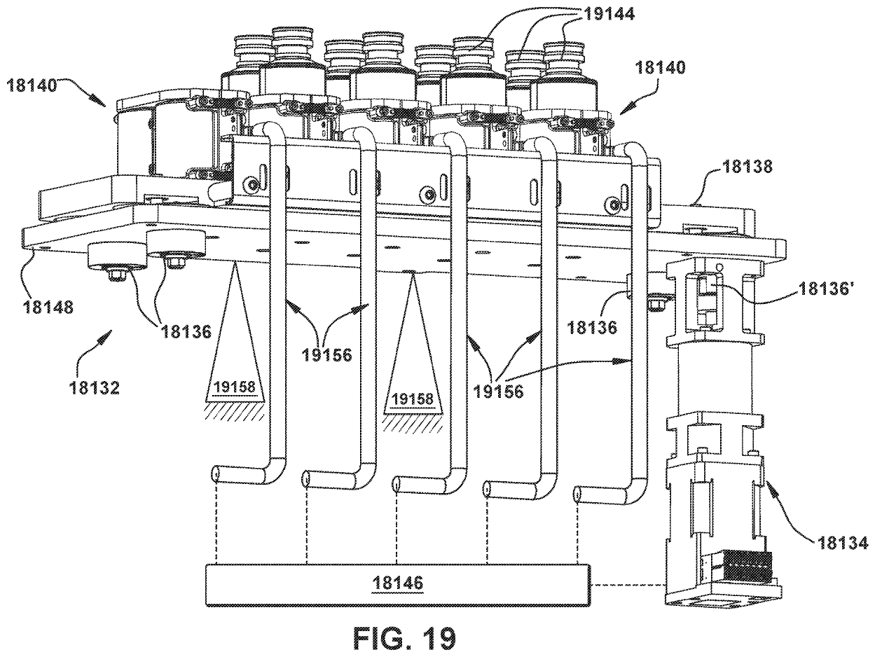

The material thawing device 18132 includes a stepper motor 18134 and at least one eccentric cam 18136 operatively coupled to the stepper motor 18134 and receiving rotary motion therefrom. A mobile platform 18138 is selectively driven by the eccentric cam(s) 18136 into orbital motion within a motion plane MP with respect to the stepper motor 18134. The motion plane MP is substantially parallel to the mobile platform 18138, such that the mobile platform 18138 gyrates or shifts in a flat, substantially level manner without significant motion outside the motion plane MP—the container units can thus be swirled or mixed substantially without precessing motion substantially out of the motion plane MP. (The motion plane MP is schematically shown, for example, in FIG. 18) At least one container station 18140 is supported by the mobile platform for orbital motion parallel to the motion plane. The at least one container station 18140 includes a heating element 18142 for selectively heating a container 19144 (shown in FIGS. 19-20 and 24-26) which is associated with the container station 18140.

A thawing controller (shown schematically at 18146) is configured to control at least one of the heating element 18142 and the stepper motor 18134 responsive to a respective predetermined heating cycle and/or motion cycle (A.K.A., “swirler” or “swirling” cycle). For example, when controlling a motion or swirling cycle, the thawing controller 18146 controls the stepper motor 18134 to induce “swirling” type orbital motion of the mobile platform 18138 within the motion plane MP relative to a platform home position. If the stepper motor 18134 is controlled in a suitable manner, the platform home position can be used as a relatively fixed “origin point” for operation of the material thawing device 18132, such that the container stations 18140 can be controlled in space to a known and repeatable “home” position. This may be useful, for example, in automated cryostorage units 100 and use environments such as, but not limited to, those shown and described in the '834 patent.

A baseplate 18148 may be held stationary relative to the mobile platform 18138. The baseplate 18148, when present, may define a station for maintaining the eccentric cam 18136 in position relative thereto. The motion plane MP of the mobile platform 18138 extends substantially parallel to the baseplate 18148. The baseplate 18148 could be used, for example, to constrain motion of one or more eccentric cams 18136 and provide a relatively stable platform for attachment of other structures of the material thawing device 18132.

The eccentric cam 18136′, as labeled in the Figures, may be a first eccentric cam of a plurality of eccentric cams 18136 being maintained in position relative to the baseplate 18148. The first eccentric cam 18136′ (differentiated by the “prime” mark on the element number) is directly driven by the stepper motor 18134 as a “driver” cam, and at least one other eccentric cam 18136 of the plurality of eccentric cams 18136 is indirectly driven as a “follower” cam, via motion of the mobile platform 18 138 relative to the baseplate 18148, as shown in the Figures.

It is contemplated, though, that one of ordinary skill in the art will be able to readily provide a suitable motive arrangement, whether or not a stepper motor 18134 and/or any cams are provided, for desired “swirling” orbital motion of the mobile platform 18138 within the motion plane MP. For example, a belt drive, laterally oriented crank, magnetic slider, or any other desired mechanism could be provided to induce the described planar orbital motion of the mobile platform 18 138, as desired.

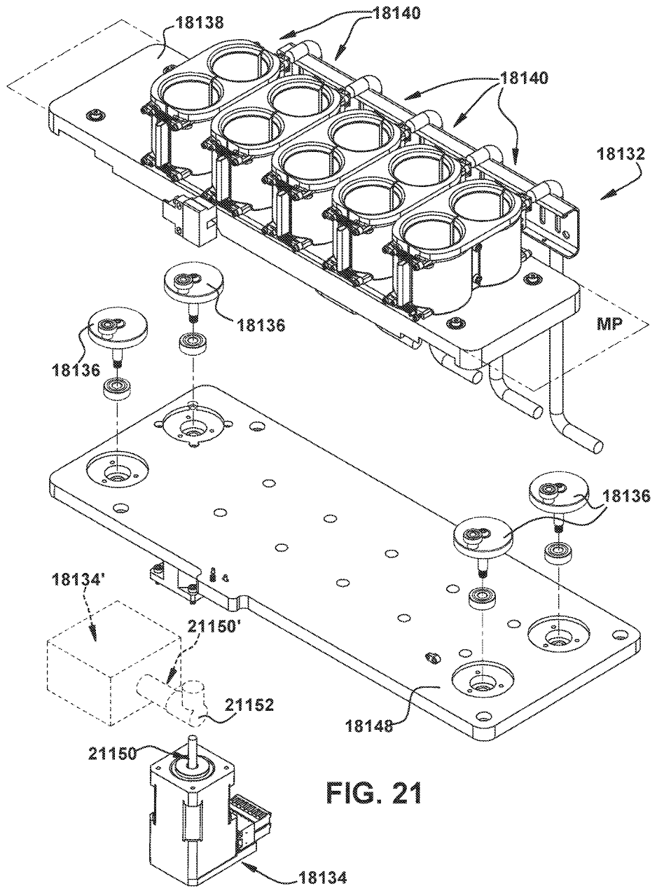

With reference now to the exploded view of FIG. 21, the stepper motor 18134 may apply rotary motion to at least the directly driven one of the eccentric cams 18136′ via a motor shaft 21150 extending substantially perpendicular to the motion plane MP of the mobile platform 18138. It is contemplated, though, that a stepper motor 18134′ may instead apply rotary motion to at least the directly driven one of the eccentric cams 18136′ via a motor shaft 21150′ extending substantially parallel to the motion plane MP of the mobile platform 18138, transmitting rotary motion via a directional-change linkage 21152 (e.g., a universal joint, gear train, belt drive, or other suitable mechanism) to the eccentric cam 18136′). This directional-change situation is shown in broken line in FIG. 21, and may be useful, for example, when space beneath the baseplate 18148 is constrained, or for any other desired reason.

With reference again to FIG. 19, a line 19156 (which may be an electrical line) may be provided to one or more of the container stations 18140, and be used to supply electrical power thereto in order to run the heating element 18142 as instructed by the thawing controller 18146. It is contemplated that lines 19156 could instead be used to route a heating fluid to each container station 18140 when liquid-based heating is desired, and/or could be used to route coolant for a cooling application of the material thawing device 18132. For example, one or more container stations 18140 could be configured to provide heating and/or cooling properties, using electrical and/or fluid-based heating/cooling elements, in a particular use environment, such as, for example, when it is desirable for a container 19144 to be thawed or warmed somewhat from cryogenic temperatures but maintained at a temperature below ambient. The lines 19156, when present, may include flexible portions or other provisions for facilitating the swirling orbital motion of the mobile platform 18138 without placing unwanted stress on the connections or any structures to which the lines 19156 are connected.

Also as shown in FIG. 19, the baseplate 18148 and/or mobile platform 18138 are shown without supports, but it is contemplated that one or more pylons (shown schematically at 19158) or other supporting structures could be provided to support the weight of the baseplate 18148 and structures carried thereby (including the stepper motor 18134 and eccentric cams), without impeding the described orbital motion within the motion plane MP of the mobile platform 18138. Similarly, it is contemplated that the baseplate 18148, or any other structure of material thawing device 18132, could be supported by or within a housing of any suitable configuration, which can be really provided by one of ordinary skill in the art for a desired use environment.

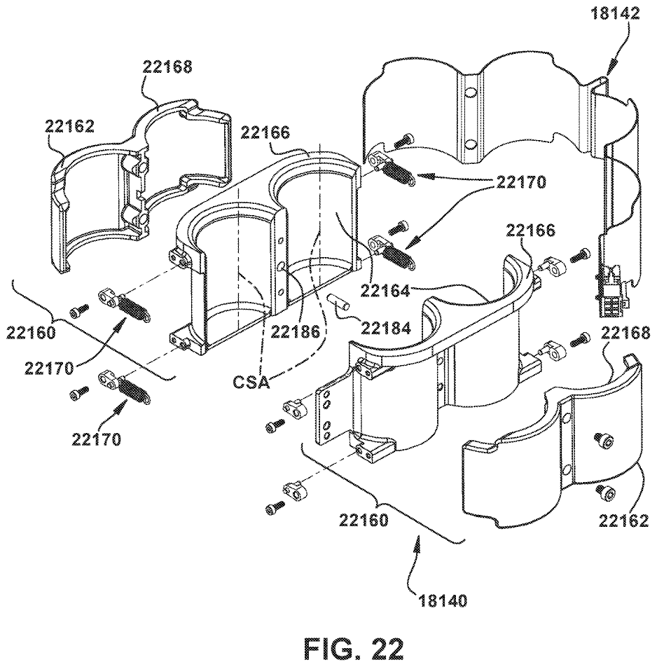

With reference now to FIGS. 22-26, a container station 18140 is shown in detail. The depicted container station 18140 is configured to selectively hold two containers 19144 and 19144′, though it is contemplated that one of ordinary skill in the art can readily provide a container station 18140 configured to hold any desired number of containers 19144, in any desired manner, and to provide the containers 19144 with any desired temperature-change facilitators.

The container station 18140 includes a plurality of longitudinally extending grasper shell portions 22160 biased toward one another. The grasper shell portions 22160 collectively surround the container 19144 to exert a compressive force toward a longitudinally extending central station axis CSA and resist motion of the container 19144 from a container warming position defined by the container station 18140. (While the container stations 18140 shown in the Figures are each configured to hold two containers 19144 side-by-side, the description herein presumes that each “half” of these tandem structures can be considered a single container station 18140. It is also contemplated that container stations could be provided by one of ordinary skill in the art to hold any desired number of containers 19144 at one time, and in any relative spatial arrangement[s].) As shown in at least FIGS. 24-26, a grasped portion of the/each container 19144 is substantially cylindrical and each grasper shell portion 22160 has a hemicylindrical profile.

Each grasper shell portion 22160 includes an outer grasper skin 22162 and an inner container-contacting layer 22164. At least a portion of the heating element 18142 is interposed laterally between the outer grasper skin 22162 and the inner container-contacting layer 22164. Inner layer 22164 may be at least partially made of high conductivity material, such as aluminum, to provide uniform temperature and dispersion of heat received from element 18142 to the container-contacting surface of inner layer 22164. Outer skin 22162 may be at least partially made of a substantially rigid, low-conductivity thermal insulator and serves to preserve contact between inner layer 22164 and heating element 18142 while minimizing loss of heat to the ambient surroundings. In some use environments, the heating element 18142 may be a dry heating element, such as the resistive heating element shown in at least FIG. 22.

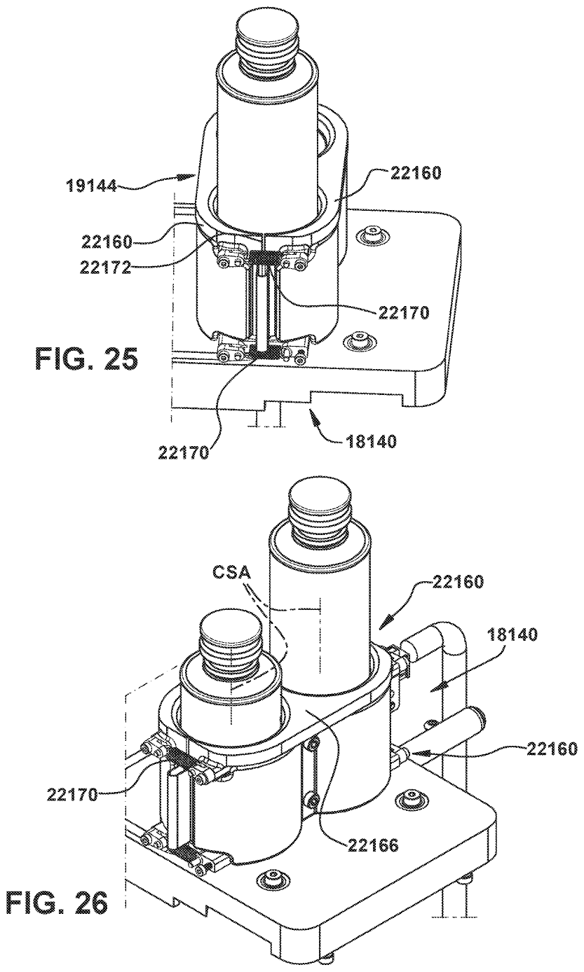

Through use, for example, of the biasing springs 22170 shown in FIG. 22, the plurality of grasper shell portions 22166 may be biased toward one another at an intermediate longitudinal portion thereof, such that an uppermost end of one grasper shell portion 22170 splays outward from the other shell portion under pressure from insertion of the container 19144 downward toward the container warming position. This splaying is demonstrated by gap 24172 shown in FIG. 25 opening slightly between the upper rims 22166 of the two lateral halves of the container station 18140. Preferably, one half (one grasper shell portion 22160) is fixed to the mobile platform, and the other half is connected to the first by springs 22170, allowing separation between the halves to receive a container 19144, but maintaining contact pressure with the container 19144. A pin 22184 may be provided on the fixed half, protruding toward the movable half and engaging with a mating cavity 22186 in the movable half with clearance sufficient to allow relative angular motion between the halves during insertion and removal of containers 19144, but preventing significant lifting of the movable half by its frictional contact with the container(s) during extraction. The uppermost ends of the grasper shell portions 22170 then return toward the central station axis CSA when the container 19144 achieves the container warming position. Depending on the force of the biasing springs 22170, this gap 24172 could close with a “snap” audible and/or tactile sensation, to assist the user in achieving knowledge of proper seating of the container 19144 into the container warming position. It is contemplated that the upper rims 22166 or any other portion of the container stations 18140 could be dimensioned for accepting interaction with a particular configuration of container 19144, as desired by one of ordinary skill in the art.

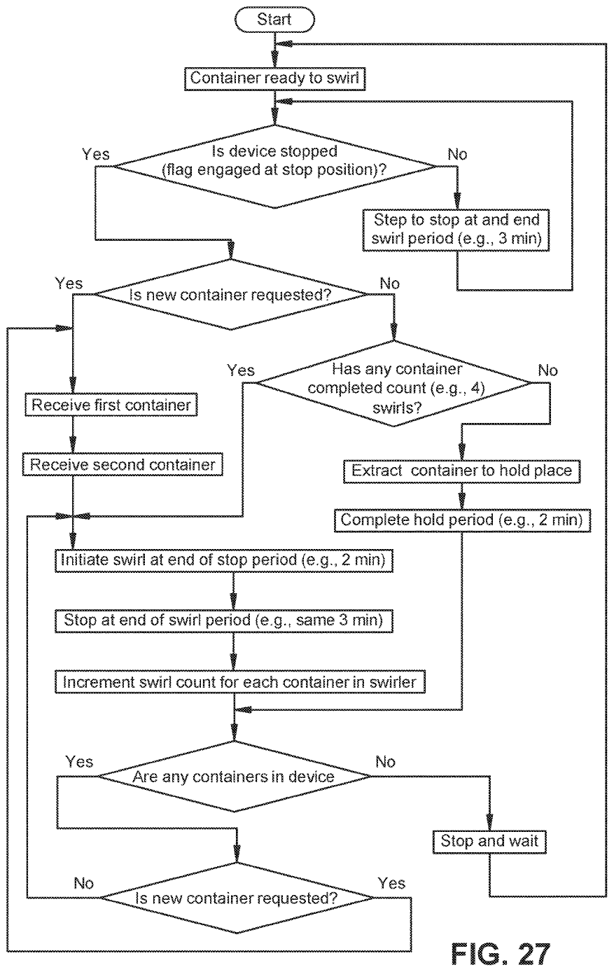

Once each container(s) 19144 associated with a particular container station 18140 have achieved the container warming position, a container warming cycle, including one or more of application of heat (and/or cooling), application of swirling type motion, passage of time, achievement of a predetermined temperature, and/or any other factors to provide a container 19144 with a desired treatment via the material following device 18132. A flowchart outlining control and operation of a material thawing device 18132 in an example use application is shown in FIG. 27. One of ordinary skill in the art can readily provide suitable logic and control for operation of a material thawing device 18132 in a particular use environment

FIGS. 28-31 depict various views of a cartridge or rack 210 which can be used in conjunction with the cryostorage unit 100 and carousel deck 146 previously described. The rack 210 shown in these Figures includes a solid bottom plate 28174 and an apertured top plate 28176, extending substantially parallel to the bottom plate 28174. A plurality of column rods 28178 extend longitudinally between the bottom and top plates 28174 and 28176, to lend columnar strength to the rack 210 and to define the holding locations for the containers 19114. Identifying information 28180 such as, but not limited to, a user-perceptible marking and/or an RFID label, may be provided on any desired surface of the rack 210 to assist with identifying the rack itself and/or the contents thereof.

At least one bumper 28182 can be provided on one or more column rods 28178, to assist with stabilizing, shock-absorbing, positioning, indexing, or any other desired tasks, particularly as relates to one or more containers 19144 carried by the rack 210. The bottom and top plates 28174 into 8176 may have any desired footprints, such as, but not limited to, the somewhat congruent shapes shown in the Figures. The bottom plate 28174 may be slightly smaller, overall, than the top plate 28176. The bottom plate 28174 may be configured for insertion through the rack aperture 856 of a carousel deck 146 of a cryostorage unit 100, such as that shown in FIG. 1. In such a use environment, the top plate 28176 may be configured to be larger than the rack aperture 856 and thus unable to fit therethrough. Accordingly, the top plate 28176 is configured to “catch” on the carousel disk 854 and facilitate suspension of the column rods 28178, bottom plate 28174, and any containers 19144 being carried by the rack 210 into the internal volume 208 as shown schematically in at least FIG. 2. The size, shape, location, and other characteristics of the apertures on the top plate 28176, the bottom and top plates themselves 28174 and 28176, and any other components of the rack 210 may be chosen to facilitate placement of one or more containers 19144 in predetermined positions, optionally in a repeatable manner. As a result, the rack 210 shown in FIGS. 28-31 may be helpful in facilitating automated retrieval of containers 19144 in cryostorage units 100 similar to that taught by the '834 patent.

The structures, components, and functions of the components shown and described herein could be used, as desired, with a cryostorage unit having any suitable type of access scheme (i.e., not necessarily the described carousel-type interface). For example, aspects of the herein-described structures and/or functions could be readily provided by one of ordinary skill in the art to a cryostorage unit having manual or automatic access to a rack of containers (removable from the cryochamber), a simple reach-in automatic or manual access procedure, any other procedure for moving materials into and/or out of the cryochamber, or any combination thereof.

In summary, a person having ordinary skill in the art will understand that an example aspect 1 includes a cryostorage unit, comprising:
a cryochamber configured to store at least one rack in a cryogenic internal volume defined by the cryochamber, the cryochamber including a cryo-access port at an upper portion of the cryochamber, the cryo-access port being configured to place the internal volume in fluid communication with an ambient space via a port aperture extending through a top cryochamber surface, the cryo-access port being at least partially defined by a port collar in fluid communication with the port aperture and extending longitudinally upward beyond the upper portion of the cryochamber; and
a cork selectively occluding the cryo-access port for resisting ingress of ambient air to the cryochamber, the cork including a lower cork body having a first cross-sectional footprint and configured for selective nesting engagement within the port collar, and the cork including an upper lid feature having a second cross-sectional footprint, larger in at least one dimension than the first cross-sectional footprint;
wherein at least a portion of the port collar includes a cork seat feature configured for selective engagement with at least a portion of the upper lid feature to resist travel of fluid along a longitudinal fluid path between the cork and the port collar.

Example aspect 2. The cryostorage unit of example aspect 1, wherein the upper lid feature is configured for a selective interference fit with the cork seat feature.

Example aspect 3. The cryostorage unit of example aspect 1, wherein the upper lid feature includes a protruding rim, the cork seat feature includes an increased-footprint seat lip at an upper portion of the port collar, and wherein the protruding rim selectively rests upon the seat lip as the cork is nested into the port collar to resist travel of fluid between the cryogenic interior volume and the ambient space.

Example aspect 4. The cryostorage unit of example aspect 3, including a resilient sealing element carried by a selected one of the protruding rim and the seat lip, at least a portion of the sealing element being interposed vertically between the protruding rim and the seat lip when the cork is nested into the port collar.

Example aspect 5. The cryostorage unit of example aspect 3, wherein the cork seat feature includes a vertically extending seat wall protruding upward from the seat lip, the seat wall laterally surrounding at least a portion of an outer perimeter of the protruding rim.

Example aspect 6. The cryostorage unit of example aspect 5, wherein at least a chosen one of the seat wall and the protruding rim includes a resilient sealing element on a laterally-facing surface thereof, for sealing against an other one of the seat wall and the protruding rim.

Example aspect 7. The cryostorage unit of example aspect 6, wherein the chosen one of the seat wall and the protruding rim includes a laterally-extending groove for maintaining at least a portion of the sealing element therein.

Example aspect 8. The cryostorage unit of example aspect 3, wherein the protruding rim includes an overhanging wall extending vertically downward from an outer perimeter thereof, the overhanging wall laterally surrounding at least a portion of an outer perimeter of the seat lip.

Example aspect 9. The cryostorage unit of example aspect 8, wherein at least a chosen one of the overhanging wall and the protruding rim includes a resilient sealing element on a laterally-facing surface thereof, for sealing against an other one of the overhanging wall and the protruding rim.

Example aspect 10. The cryostorage unit of example aspect 1, wherein the cork and the cryo-access port are both substantially circular in lateral cross-section.

Example aspect 11. The cryostorage unit of example aspect 1, including an external dry air supply line in fluid-supplying communication with a ventilation space laterally between the cork and the port collar.

Example aspect 12. The cryostorage unit of example aspect 11, wherein a resilient sealing element is interposed between the cork seat feature and the upper lid feature, the resilient sealing element including a plurality of manifold apertures configured to direct fluid from the dry air supply line to the ventilation space.

Example aspect 13. The cryostorage unit of example aspect 1, wherein the lower cork body includes a dry air channel extending vertically therethrough, the dry air channel being configured to place an external dry air supply line into fluid communication with the cryogenic interior volume.

A person having ordinary skill in the art will understand that an example aspect 14 includes a cryostorage unit, comprising:
a cryochamber configured to store at least one rack in a cryogenic
internal volume defined by the cryochamber, the cryochamber including a cryo-access port at an upper portion of the cryochamber, the cryo-access port being configured to place the internal volume in fluid communication with an ambient space via a port aperture extending through a top cryochamber surface;
a cork selectively occluding the cryo-access port for resisting ingress of ambient air to the cryochamber; and
a dry air supply device at least partially external to the cryogenic internal volume, the dry air supply device including a dry air supply line in fluid communication with at least a chosen one of the cryogenic internal volume and the cryo-access port;

wherein the dry air supply device selectively provides dry air to volumetrically prevent intrusion of non-dry air within the chosen one of the cryogenic internal volume and the cryo-access port.

Example aspect 15. The cryostorage unit of example aspect 14, wherein the dry air has a dewpoint at or below −40° C.

Example aspect 16. The cryostorage unit of example aspect 14, wherein the dry air supply device includes a pump for compressing ambient air, a dryer for accepting the compressed ambient air from the pump and removing moisture to produce dry air for routing to the dry air supply line, and a throttle in fluid communication with the dry air supply line for selectively changing a rate of dry air flowing therethrough to the cryogenic internal volume.

Example aspect 17. The cryostorage unit of example aspect 16, wherein the throttle changes a rate of dry air flowing through the dry air supply line responsive to a sensed condition within the chosen one of the cryogenic internal volume and the cryo-access port.

Example aspect 18. The cryostorage unit of example aspect 16, wherein the throttle provides a predetermined rate of dry air flowing through the dry air supply line responsive to a sensed position of the cork relative to the port collar.

Example aspect 19. The cryostorage unit of example aspect 16, wherein the dry air supply device includes a buffer tank interposed fluidically between the dryer and the throttle, the buffer tank facilitating selective variability of a quantity of dry air traveling through the dry air supply line.

Example aspect 20. The cryostorage unit of example aspect 14, wherein the cryo-access port is at least partially defined by a port collar in fluid communication with the port aperture and extending longitudinally upward beyond the upper portion of the cryochamber;
wherein the cork includes a lower cork body having a first cross-sectional footprint and configured for selective nesting engagement within the port collar, the cork including an upper lid feature having a second cross-sectional footprint, larger in at least one dimension than the first cross-sectional footprint; wherein
wherein at least a portion of the port collar includes a cork seat feature configured for selective engagement with at least a portion of the upper lid feature to resist travel of fluid along a longitudinal fluid path between the cork and the port collar.

Example aspect 21. The cryostorage unit of example aspect 20, wherein the external dry air supply line is in fluid-supplying communication with a ventilation space laterally between the cork and the port collar.

Example aspect 22. The cryostorage unit of example aspect 21, wherein a resilient sealing element is interposed between the cork seat feature and the upper lid feature, the resilient sealing element including a plurality of manifold apertures configured to direct fluid from the dry air supply line to the ventilation space.

Example aspect 23. The cryostorage unit of example aspect 20, wherein the lower cork body includes a dry air channel extending vertically therethrough, the dry air channel being configured to place an external dry air supply line into fluid communication with the cryogenic interior volume.

A person having ordinary skill in the art will understand that an example aspect 24 includes a material thawing device, comprising:
a stepper motor;
an eccentric cam operatively coupled to the stepper motor and
receiving orbital motion therefrom;
a mobile platform selectively driven by the eccentric cam into orbital motion within a motion plane with respect to the stepper motor, the motion plane being substantially parallel to the mobile platform; and
at least one container station supported by the mobile platform for orbital motion parallel to the motion plane, the at least one container station including a heating element for selectively heating a container associated with the container station.

Example aspect 25. The material thawing device of example aspect 24, including a thawing controller configured to control at least one of the heating element and the stepper motor responsive to a respective predetermined heating cycle and motion cycle.

Example aspect 26. The material thawing device of example aspect 25, wherein the thawing controller controls the stepper motor to induce orbital motion of the mobile platform within the motion plane relative to a platform home position.

Example aspect 27. The material thawing device of example aspect 24, including a baseplate held stationary relative to the mobile platform, the baseplate defining a station for maintaining the eccentric cam in position relative thereto, the motion plane of the mobile platform extending substantially parallel to the baseplate.

Example aspect 28. The material thawing device of example aspect 26, wherein the eccentric cam is a first eccentric cam of a plurality of eccentric cams being maintained in position relative to the baseplate, the first eccentric cam being directly driven by the stepper motor, and at least one other eccentric cam of the plurality of eccentric cams being indirectly driven via motion of the mobile platform relative to the baseplate.

Example aspect 29. The material thawing device of example aspect 24, wherein the stepper motor applies rotary motion to the eccentric cam via a motor shaft extending substantially perpendicular to the motion plane of the mobile platform.

Example aspect 30. The material thawing device of example aspect 24, wherein the stepper motor applies rotary motion to the eccentric cam via a motor shaft extending substantially parallel to the motion plane of the mobile platform, transmitting rotary motion via a directional-change linkage to the eccentric cam.

Example aspect 31. The material thawing device of example aspect 24, wherein the container station includes a plurality of longitudinally extending grasper shell portions biased toward one another, the grasper shell portions collectively surrounding the container to exert a compressive force toward a longitudinally extending central station axis and resist motion of the container from a container warming position defined by the container station.

Example aspect 32. The material thawing device of example aspect 31, wherein a grasped portion of the container is substantially cylindrical and each grasper shell portion has a hemicylindrical profile.

Example aspect 33. The material thawing device of example aspect 31, wherein each grasper shell portion includes an outer grasper skin, an inner container-contacting layer, and at least a portion of the heating element interposed laterally between the outer grasper skin and the inner container-contacting layer.

Example aspect 34. The material thawing device of example aspect 33, wherein the container station includes an upper rim affixed to a selected one of the grasper halves, the upper rim permitting only a predetermined amount of lateral motion relative thereto by the other one of the grasper halves

Example aspect 35. The material thawing device of example aspect 31, wherein the plurality of grasper shell portions are biased toward one another at an intermediate longitudinal portion thereof, such that an uppermost end of one grasper shell portion splays outward from the central station axis under pressure from insertion of the container downward toward the container warming position, the uppermost ends of the grasper shell portions returning toward one another when the container achieves the container warming position.

Example aspect 36. The material thawing device of example aspect 24, wherein the heating element is a dry heating element.

A person having ordinary skill in the art will understand that an example aspect 37 includes cryostorage unit, comprising:
a cryochamber including a cryo-access port at an upper portion of the cryochamber, the cryochamber defining an internal volume substantially surrounding at least one rack, the cryo-access port being configured to selectively place the internal volume in fluid communication with an ambient space;
a cooling agent inducing cryogenic temperatures within a first temperature range to the interior volume;
a carousel deck located within the internal volume adjacent the cryo-access port, the carousel deck being located substantially above the at least one rack and suspending the at least one rack downward therefrom into the internal volume; and
at least one carousel bearing located in the internal volume and engaging with the carousel deck rotational motion of the carousel deck relative to the cryochamber, the carousel deck rotating substantially horizontally.

Example aspect 38. The cryostorage unit of example aspect 37, wherein the cryo-access port includes an aperture extending through a top cryochamber surface, the aperture being located non-coaxially with a central vertical axis of the cryochamber.

Example aspect 39. The cryostorage unit of example aspect 37, wherein the cryo-access port is located substantially coaxially with a central vertical axis of the cryochamber.

Example aspect 40. The cryostorage unit of example aspect 37, wherein the cooling agent includes an elongate heat exchanger suspended into the internal volume.

Example aspect 41. The cryostorage unit of example aspect 40, wherein the elongate heat exchanger extends substantially coaxially with a central vertical axis of the cryochamber.

Example aspect 42. The cryostorage unit of example aspect 37, wherein the cooling agent includes a fluid coolant selectively directed into the internal volume.

Example aspect 43. The cryostorage unit of example aspect 37, including a housing substantially surrounding the cryochamber and selectively placing the cryo-access port into fluid communication with the ambient space.

Example aspect 44. The cryostorage unit of example aspect 37, wherein the at least one rack is configured to selectively support at least one container unit for cryogenically stored material.

Example aspect 45. The cryostorage unit of example aspect 37, including an actuator revolver for selective insertion through the cryo-access port from an ambient space to induce rotational motion of the carousel deck.

Example aspect 46. The cryostorage unit of example aspect 37, wherein the actuator revolver drives an edge feature of the carousel deck to induce rotational motion thereof.

Example aspect 47. The cryostorage unit of example aspect 46, wherein the edge feature is a toothed rim.

Example aspect 48. The cryostorage unit of example aspect 37, including a drive unit located substantially within the internal volume for inducing rotational motion of the carousel deck.

Example aspect 49. The cryostorage unit of example aspect 37, wherein the at least one carousel bearing is connected to the inner surface of the cryochamber adjacent the upper portion thereof.

Example aspect 50. The cryostorage unit of example aspect 37, wherein the at least one carousel bearing includes an axle frame carrying a rotatable wheel, the axle frame being connected to the inner surface of the cryochamber and the rotatable wheel being in rotational contact with the carousel deck.

Example aspect 51. The cryostorage unit of example aspect 50, wherein the axle frame holds the rotatable wheel in a C-slot thereof, the C-slot being open on upper and lower longitudinally separated surfaces of the axle frame.

Example aspect 52. The cryostorage unit of example aspect 50, wherein at least one of a lower and an upper surface of the carousel deck includes a groove for rotational support of the carousel deck by the rotatable wheel.

Example aspect 53. The cryostorage unit of example aspect 37, including a cork selectively occluding the cryo-access port for resisting ingress of ambient air to the cryochamber.

While aspects of this disclosure have been particularly shown and described with reference to the example aspects above, it will be understood by those of ordinary skill in the art that various additional aspects may be contemplated. For example, the specific methods described above for using the apparatus are merely illustrative; one of ordinary skill in the art could readily determine any number of tools, sequences of steps, and/or other means and options for placing the above-described apparatus, or components thereof, into positions substantively similar to those shown and described herein. In an effort to maintain clarity in the Figures, certain ones of duplicative components shown have not been specifically numbered, but one of ordinary skill in the art will realize, based upon the components that were numbered, the element numbers which should be associated with the unnumbered components; no differentiation between similar components is intended or implied solely by the presence or absence of an element number in the Figures. Any of the described structures and components could be integrally formed as a single unitary or monolithic piece or made up of separate sub-components, with either of these formations involving any suitable stock or bespoke components and/or any suitable material or combinations of materials. Any of the described structures and components could be disposable or reusable as desired for a particular use environment. Any component could be provided with a user-perceptible marking to indicate a material, configuration, at least one dimension, or the like pertaining to that component, the user-perceptible marking potentially aiding a user in selecting one component from an array of similar components for a particular use environment. A “predetermined” status may be determined at any time before the structures being manipulated actually reach that status, the “predetermination” being made as late as immediately before the structure achieves the predetermined status. The term “substantially” is used herein to indicate a quality that is largely, but not necessarily wholly, that which is specified—a “substantial” quality admits of the potential for some relatively minor inclusion of a non-quality item. Though certain components described herein are shown as having specific geometric shapes, all structures of this disclosure may have any suitable shapes, sizes, configurations, relative relationships, cross-sectional areas, or any other physical characteristics as desirable for a particular application. Any structures or features described with reference to one aspect or configuration could be provided, singly or in combination with other structures or features, to any other aspect or configuration, as it would be impractical to describe each of the aspects and configurations discussed herein as having all of the options discussed with respect to all of the other aspects and configurations. A device or method incorporating any of these features should be understood to fall under the scope of this disclosure as determined based upon the claims below and any equivalents thereof.

Other aspects, objects, and advantages can be obtained from a study of the drawings, the disclosure, and the appended claims.

1.-30. (canceled)

31. A cryostorage unit, comprising:
a cryochamber configured to store at least one rack in a cryogenic internal volume defined by the cryochamber, the cryochamber including a cryo-access port at an upper portion of the cryochamber, the cryo-access port being configured to place the internal volume in fluid communication with an ambient space via a port aperture extending through a top cryochamber surface;
a cork selectively occluding the cryo-access port for resisting ingress of ambient air to the cryochamber; and
a dry air supply device at least partially external to the cryogenic internal volume, the dry air supply device including a dry air supply line in fluid communication with at least a chosen one of the cryogenic internal volume and the cryo-access port;
wherein the dry air supply device selectively provides dry air to volumetrically prevent intrusion of non-dry air within the chosen one of the cryogenic internal volume and the cryo-access port.

32. The cryostorage unit of claim 31, wherein the dry air has a dewpoint at or below −40° C.

33. The cryostorage unit of claim 31, wherein the dry air supply device includes a pump for compressing ambient air, a dryer for accepting the compressed ambient air from the pump and removing moisture to produce dry air for routing to the dry air supply line, and a throttle in fluid communication with the dry air supply line for selectively changing a rate of dry air flowing therethrough to the cryogenic internal volume.

34. The cryostorage unit of claim 33, wherein the throttle changes a rate of dry air flowing through the dry air supply line responsive to a sensed condition within the chosen one of the cryogenic internal volume and the cryo-access port.

35. The cryostorage unit of claim 33, wherein the throttle provides a predetermined rate of dry air flowing through the dry air supply line responsive to a sensed position of the cork relative to the port collar.

36. The cryostorage unit of claim 33, wherein the dry air supply device includes a buffer tank interposed fluidically between the dryer and the throttle, the buffer tank facilitating selective variability of a quantity of dry air traveling through the dry air supply line.

37. The cryostorage unit of claim 31, wherein the cryo-access port is at least partially defined by a port collar in fluid communication with the port aperture and extending longitudinally upward beyond the upper portion of the cryochamber;
wherein the cork includes a lower cork body having a first cross-sectional footprint and configured for selective nesting engagement within the port collar, the cork including an upper lid feature having a second cross-sectional footprint, larger in at least one dimension than the first cross-sectional footprint; wherein
wherein at least a portion of the port collar includes a cork seat feature configured for selective engagement with at least a portion of the upper lid feature to resist travel of fluid along a longitudinal fluid path between the cork and the port collar.

38. The cryostorage unit of claim 37, wherein the external dry air supply line is in fluid-supplying communication with a ventilation space laterally between the cork and the port collar.

39. The cryostorage unit of claim 38, wherein a resilient sealing element is interposed between the cork seat feature and the upper lid feature, the resilient sealing element including a plurality of manifold apertures configured to direct fluid from the dry air supply line to the ventilation space.

40. The cryostorage unit of claim 37, wherein the lower cork body includes a dry air channel extending vertically therethrough, the dry air channel being configured to place an external dry air supply line into fluid communication with the cryogenic interior volume.

41.-53. (canceled)

54. The cryostorage unit of claim 37, wherein the upper lid feature is configured for a selective interference fit with the cork seat feature.

55. The cryostorage unit of claim 37, wherein the upper lid feature includes a protruding rim, the cork seat feature includes an increased-footprint seat lip at an upper portion of the port collar, and wherein the protruding rim selectively rests upon the seat lip as the cork is nested into the port collar to resist travel of fluid between the cryogenic interior volume and the ambient space.

56. The cryostorage unit of claim 55, including a resilient sealing element carried by a selected one of the protruding rim and the seat lip, at least a portion of the sealing element being interposed vertically between the protruding rim and the seat lip when the cork is nested into the port collar.

57. The cryostorage unit of claim 55, wherein the cork seat feature includes a vertically extending seat wall protruding upward from the seat lip, the seat wall laterally surrounding at least a portion of an outer perimeter of the protruding rim.

58. The cryostorage unit of claim 57, wherein at least a chosen one of the seat wall and the protruding rim includes a resilient sealing element on a laterally-facing surface thereof, for sealing against an other one of the seat wall and the protruding rim.

59. The cryostorage unit of claim 58, wherein the chosen one of the seat wall and the protruding rim includes a laterally-extending groove for maintaining at least a portion of the sealing element therein.

60. The cryostorage unit of claim 55, wherein the protruding rim includes an overhanging wall extending vertically downward from an outer perimeter thereof, the overhanging wall laterally surrounding at least a portion of an outer perimeter of the seat lip.

61. The cryostorage unit of claim 60, wherein at least a chosen one of the overhanging wall and the protruding rim includes a resilient sealing element on a laterally-facing surface thereof, for sealing against an other one of the overhanging wall and the protruding rim.

62. The cryostorage unit of claim 37, wherein the cork and the cryo-access port are both substantially circular in lateral cross-section.

63. The cryostorage unit of claim 37, including an external dry air supply line in fluid-supplying communication with a ventilation space laterally between the cork and the port collar.

64. The cryostorage unit of claim 63, wherein a resilient sealing element is interposed between the cork seat feature and the upper lid feature, the resilient sealing element including a plurality of manifold apertures configured to direct fluid from the dry air supply line to the ventilation space.

65. The cryostorage unit of claim 37, wherein the lower cork body includes a dry air channel extending vertically therethrough, the dry air channel being configured to place an external dry air supply line into fluid communication with the cryogenic interior volume.
